(19) United States
(12) Patent Application Publication
(10) Pub. No.: US 2024/0386433 A1
(43) Pub. Date: Nov. 21, 2024

(54) INTERACTIVE USER INTERFACES FOR DIGITAL CUSTOMER RELATIONSHIP MANAGEMENT

(71) Applicant: INTUIT INC., MOUNTAIN VIEW, CA (US)

(72) Inventors: Shivang Bhadresh SHAH, Mountain View, CA (US); Philippa Juta Kathleen THOMPSON, Mountain View, CA (US); Jackson SABOL, Mountain View, CA (US); Erick SHENK, Mountain View, CA (US); Kylie TUOSTO, Mountain, CA (US)

(73) Assignee: INTUIT INC., MOUNTAIN VIEW, CA (US)

(21) Appl. No.: 18/317,887

(22) Filed: May 15, 2023

(51) Int. Cl. G06Q 30/01; G06Q 50/00

(52) U.S. Cl. CPC G06Q 30/01; G06Q 50/01

(57) ABSTRACT

Customizable template-based user interfaces for digital CRM tools. For instance, the CRM tools are pre-loaded with customizable templates, which are rendered as interactive user interfaces that allow customization of the templates based on user needs. This customization therefore allows a user to rapidly, visually, and easily define a customer engagement pipeline and customer segments without any specialized programming knowledge. The user interfaces may dynamically show the flow of customers between different phases and provide recommended actions to further drive customer engagement. Additionally, the CRM tools are integrated with other on-line platforms such as social media sites and e-commerce sites.

### BACKGROUND

The ongoing information revolution has changed the world in many ways. While the industrial revolution of the eighteenth and nineteenth centuries unlocked unlimited mechanical power, the information revolution has unlocked a plethora of channels of communication. The world is being hyperconnected: news, updates, posts, advertisements, and transactions are generated and conducted in an ever-increasing scale. The sources of data have also increased exponentially as the majority of the world population can instantly generate—and disseminate—text, audio, and or video all over the world using social media platforms.

The information revolution has powered electronic commerce, which has flourished using tools such as digital marketing, electronic payments, digital customer interaction, etc. It is well known that customer's attributes-transactions, purchases, preferences, etc.—can be continuously tracked to provide advertisements and recommendations. Compared to traditional broadcast advertisements, these advertisements may be customized for a segment of customers or even for a single customer. Furthermore, customer relationship management (CRM) tools have been developed to facilitate continuous engagement with customers and potential customers.

Despite all of these improvements, significant technical challenges remain. Traditional CRM tools require a sophisticated technical and operational expertise. For example, these tools require manual coding, bug fixing, and code maintenance, which may be impractical for resource constrained small businesses. Furthermore, off-the-shelf CRM tools provide less flexibility, these tools are inherently designed to cater to a common baseline, and therefore do not allow for a desired level of customization. Additionally, these tools do not integrate with different channels of customer data. For example, data from social media feeds of the customers may have to be manually entered. Therefore, an entity using a traditional CRM tool is left with a non-integrated and static design requiring significant maintenance.

As such, a significant improvement of CRM tools is desired.

### SUMMARY

Embodiments disclosed herein solve the aforementioned technical problems and may provide other technical solutions as well. One or more embodiments provide customizable template-based user interfaces for digital CRM tools. For instance, the CRM tools are pre-loaded with customizable templates, which are rendered as interactive user interfaces that allow customization of the templates based on user needs. This customization therefore allows a user to rapidly, visually, and easily define a customer engagement pipeline and customer segments without any specialized programming knowledge. The user interfaces further dynamically show the customer flow between different phases and provide recommended actions to further drive customer engagement. Additionally, the CRM tools are integrated with other on-line platforms such as social media sites and e-commerce sites.

### BRIEF DESCRIPTION OF THE DRAWINGS

FIG. 1 shows an example of a system configured for executing a customer relationship management (CRM) tool, based on the principles disclosed herein.

FIG. 2A shows an example graphical user interface (GUI) generated by the CRM tool based on the principles disclosed herein.

FIG. 2B shows an example GUI generated by the CRM tool based on the principles disclosed herein.

FIG. 2C shows an example GUI generated by the CRM tool based on the principles disclosed herein.

FIG. 2D shows an example GUI generated by the CRM tool based on the principles disclosed herein.

FIG. 2E shows an example GUI generated by the CRM tool based on the principles disclosed herein.

FIG. 2F shows an example GUI generated by the CRM tool based on the principles disclosed herein.

FIG. 2G shows an example GUI generated by the CRM tool based on the principles disclosed herein.

FIG. 3A shows an example GUI generated by the CRM tool based on the principles disclosed herein.

FIG. 3B shows an example GUI generated by the CRM tool, based on the principles disclosed herein.

FIG. 3C shows an example GUI generated by the CRM tool based on the principles disclosed herein.

FIG. 3D shows an example GUI generated by the CRM tool based on the principles disclosed herein.

FIG. 3E shows an example GUI generated by the CRM tool based on the principles disclosed herein.

FIG. 3F shows an example GUI generated by the CRM tool based on the principles disclosed herein.

FIG. 3G shows an example GUI generated by the CRM tool based on the principles disclosed herein.

FIG. 3H shows an example GUI generated by the CRM tool based on the principles disclosed herein.

FIG. 3I shows an example GUI generated by the CRM tool based on the principles disclosed herein.

FIG. 4A shows an example GUI generated by the CRM tool based on the principles disclosed herein.

FIG. 4B shows an example GUI generated by the CRM tool based on the principles disclosed herein.

FIG. 4C shows an example GUI generated by the CRM tool based on the principles disclosed herein.

FIG. 4D shows an example GUI generated by the CRM tool based on the principles disclosed herein.

FIG. 4E shows an example GUI generated by the CRM tool based on the principles disclosed herein.

FIG. 5A shows an example GUI generated by a CRM tool based on the principles disclosed herein.

FIG. 5B shows an example GUI generated by the CRM tool, based on the principles disclosed herein.

FIG. 5C shows an example GUI generated by the CRM tool, based on the principles disclosed herein.

FIG. 6A shows an example GUI generated by the CRM tool based on the principles disclosed herein.

FIG. 6B shows an example GUI generated by the CRM tool based on the principles disclosed herein.

FIG. 6C shows an example GUI generated by the CRM tool based on the principles disclosed herein.

FIG. 6D shows an example GUI generated by the CRM tool based on the principles disclosed herein.

FIG. 6E shows an example GUI generated by the CRM tool based on the principles disclosed herein.

FIG. 6F shows an example GUI generated by the CRM tool based on the principles disclosed herein.

FIG. 7 shows a flow diagram of an example method based on the principles disclosed herein.

FIG. 8 shows a block diagram of an example computing device that implements various features and processes based on the principles disclosed herein.

### DETAILED DESCRIPTION OF SEVERAL EMBODIMENTS

Embodiments disclosed herein provide CRM tools that generate user-defined, intuitive, and interactive user interfaces. The user defines the user interfaces by configuring one or more templates (e.g., defining a customer pipeline). The user interfaces provide an intuitive view of customer flow between different phases of engagement. Additionally, the user interfaces provide interactive hyperlinks to drive customer engagement and interaction. As the customers move from lower engagement to higher engagement, the user interface updates to show the movement. The user interface also supports views of different granularities, e.g., a snapshot view, a pipeline view, a segment view, or a customer level view. The use of the CRM tools does not require specialized programming knowledge beyond basic computer literacy.

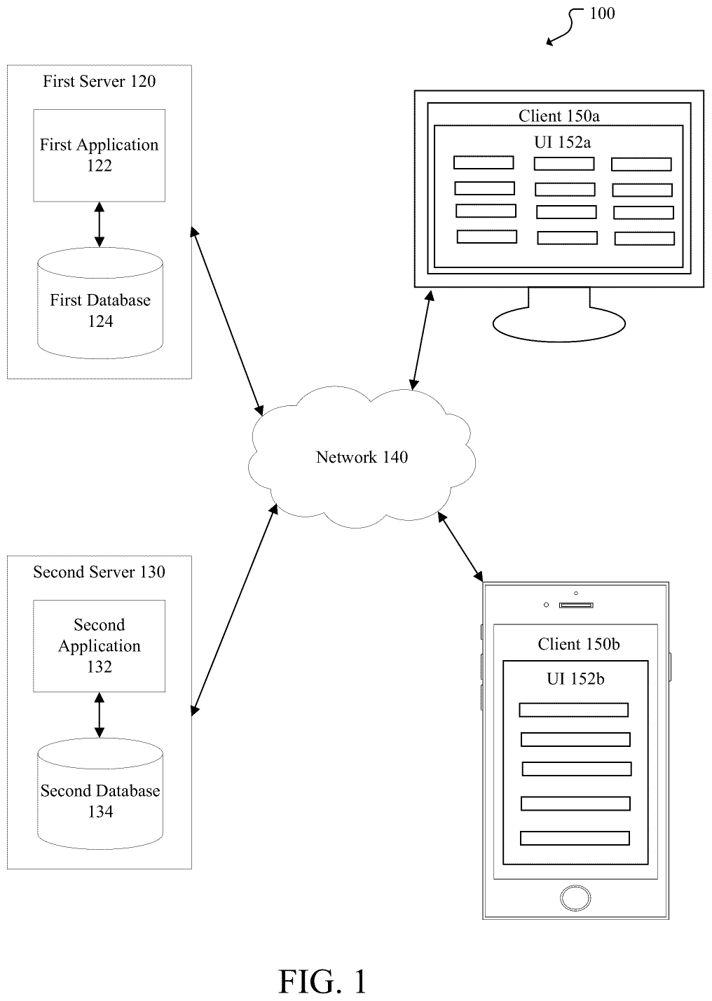

FIG. 1 shows an example of a system 100 configured for executing a customer relationship management (CRM) tool, based on the principles disclosed herein. It should be understood that the components of the system 100 shown in FIG. 1 and described herein are merely examples and systems with additional, alternative, or fewer number of components should be considered within the scope of this disclosure.

As shown, the system 100 comprises client devices 150a, 150b (collectively referred to herein as “client devices 150”) and servers 120, 130 interconnected by a network 140. The first server 120 hosts a first server application 122 and a first database 124 and the second server 130 hosts a second server application 132 and a second database 134. The client devices 150a, 150b have user interfaces 152a, 152b, respectively, (collectively referred to herein as “user interfaces (UIs) 152”), which may be used to communicate with the server applications 122, 132 using the network 140.

The server applications 122, 132 include CRM tools configured to provide a platform to interact with a plurality of customers for a current entity. That is, the server applications 122, 132 use templates to generate different UIs 152 for a user of the current entity to define a customer pipeline, a marketing funnel, a promotion campaign, and/or any other types of activities to foster customer engagement and loyalty. Another advantage provided by the server applications 122, 132 is that the user need not have specialized programming knowledge to use and maintain the CRM tools. Instead, the user interfaces 152 provide an intuitive platform for the user to deploy the CRM tools with graphics-based interaction (e.g., clicking with a mouse, selecting an option from a drop-down menu, etc.). The server applications 122, 132 further use machine learning models to generate the templates and the user interfaces 152, and the machine learning models continuously adapt and learn based on the user's behavior.

The server applications 122, 132 use corresponding databases 124, 134 to store data such as customer data. The stored data includes indications of where several customers are in a pipeline, posts made by customers about the current entity on social media platforms, customers' purchase behavior, and/or any other type of data associated with the customers. Generally, the databases 124, 143 store any type of data required by the server applications 122, 132 to generate the user interfaces 152.

Communication between the different components of the system 100 is facilitated by one or more application programming interfaces (APIs). APIs of system 100 may be proprietary and or may include such APIs as Amazon© Web Services (AWS) APIs or the like. The network 140 may be the Internet and or other public or private networks or combinations thereof. The network 140 therefore should be understood to include any type of circuit switching network, packet switching network, or a combination thereof. Non-limiting examples of the network 140 may include a local area network (LAN), metropolitan area network (MAN), wide area network (WAN), and the like.

Client devices 150 may include any device configured to present user interfaces (UIs) 152 and receive user inputs to configure the CRM tools to generate the different interfaces. Furthermore, the UIs allow the user to view the several different GUIs generated by the CRM tools.

First server 120, second server 130, first database 124, second database 134, and client devices 150 are each depicted as single devices for ease of illustration, but those of ordinary skill in the art will appreciate that first server 120, second server 130, first database 124, second database 134, and or client devices 150 may be embodied in different forms for different implementations. For example, any or each of first server 120 and second server 130 may include a plurality of servers or one or more of the first database 124 and second database 134. Alternatively, the operations performed by any or each of first server 120 and second server 130 may be performed on fewer (e.g., one or two) servers. In another example, a plurality of client devices 150 may communicate with first server 120 and or second server 130. A single user may have multiple client devices 150, and or there may be multiple users each having their own client devices 150.

Furthermore, it should be understood that the server applications 132, 134 running on the servers 120, 130, and the databases 124, 134 being hosted by the servers 120, 130 is just an example, and should not be considered limiting. Different portions of the server applications 132, 134 and, in one or more embodiments, the entirety of the server applications 132, 134 can be stored in the client devices 150. Similarly, different portions or even the entirety of the databases 124, 134 can be stored in the client devices 150. Therefore, the functionality described throughout this disclosure can be implemented at any portion of the system 100.

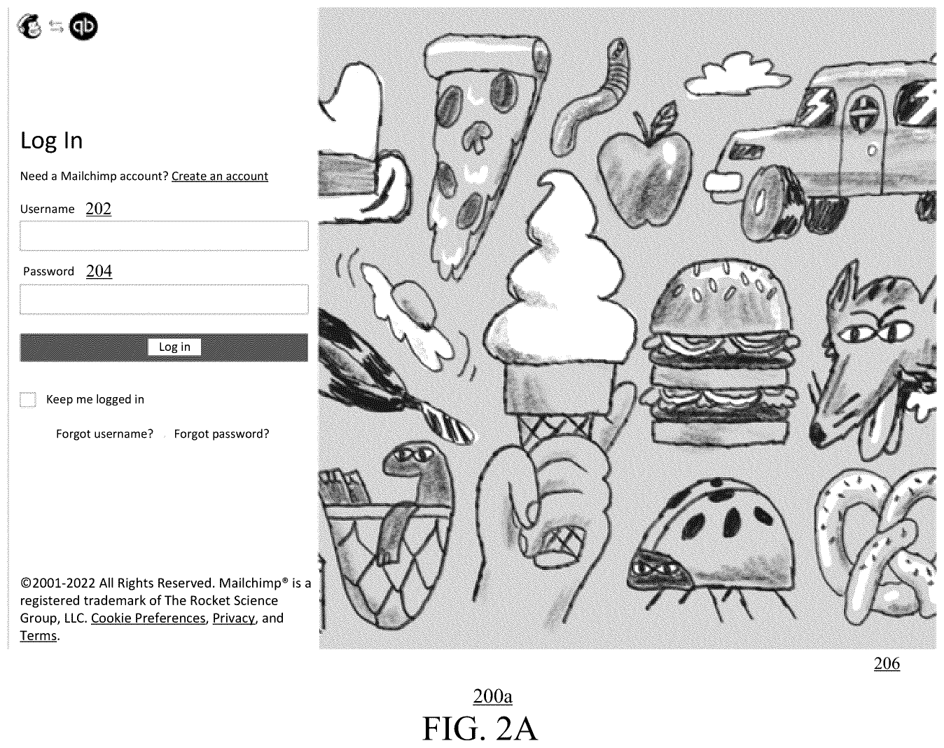

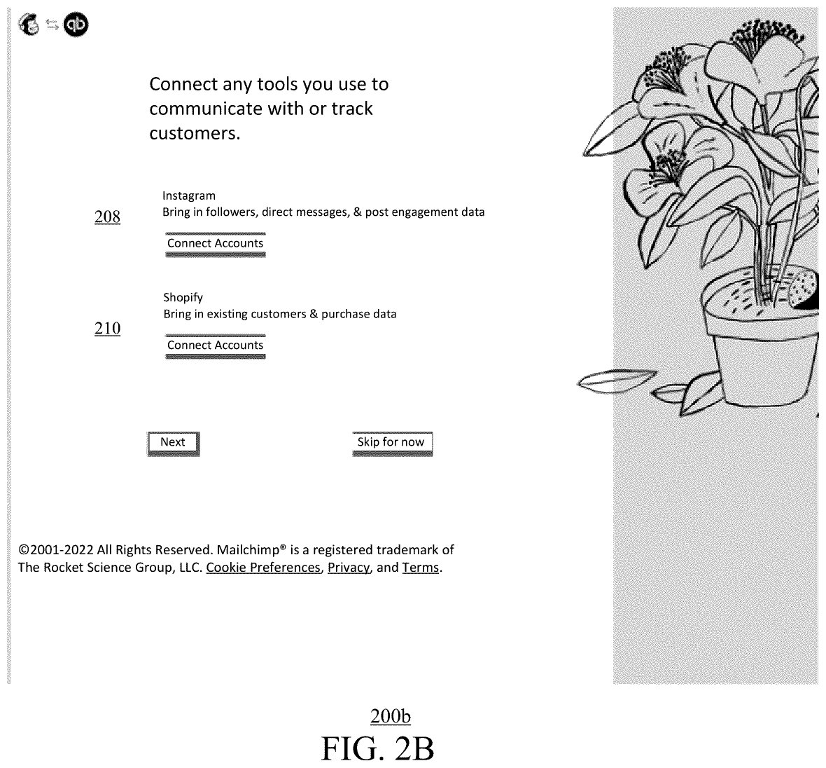

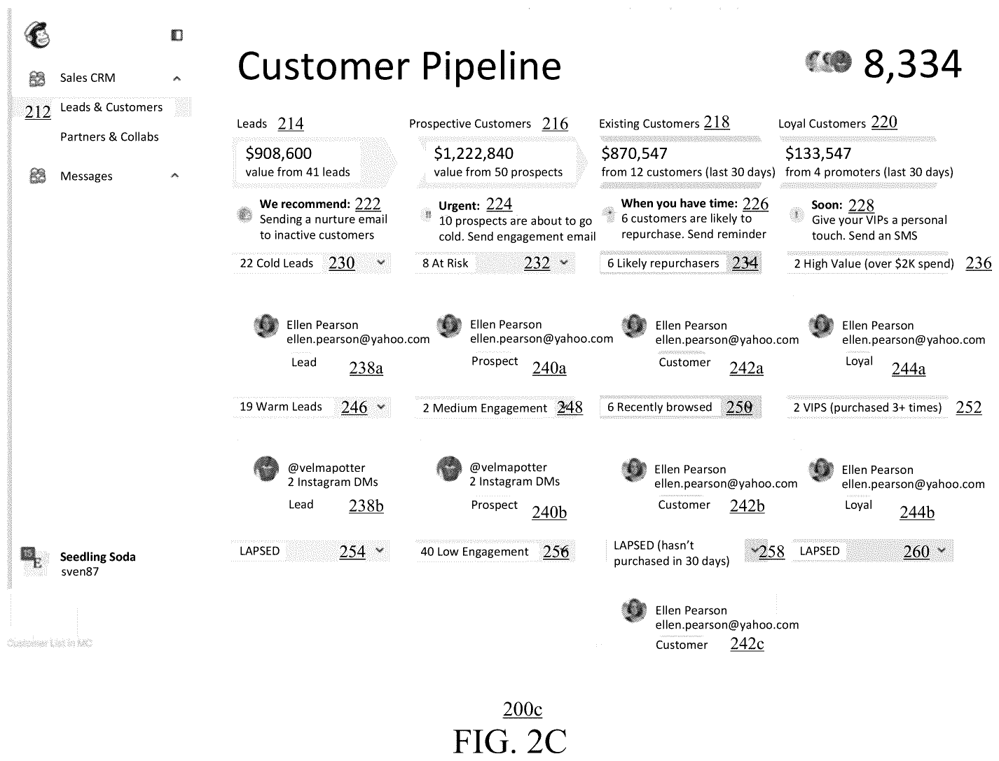

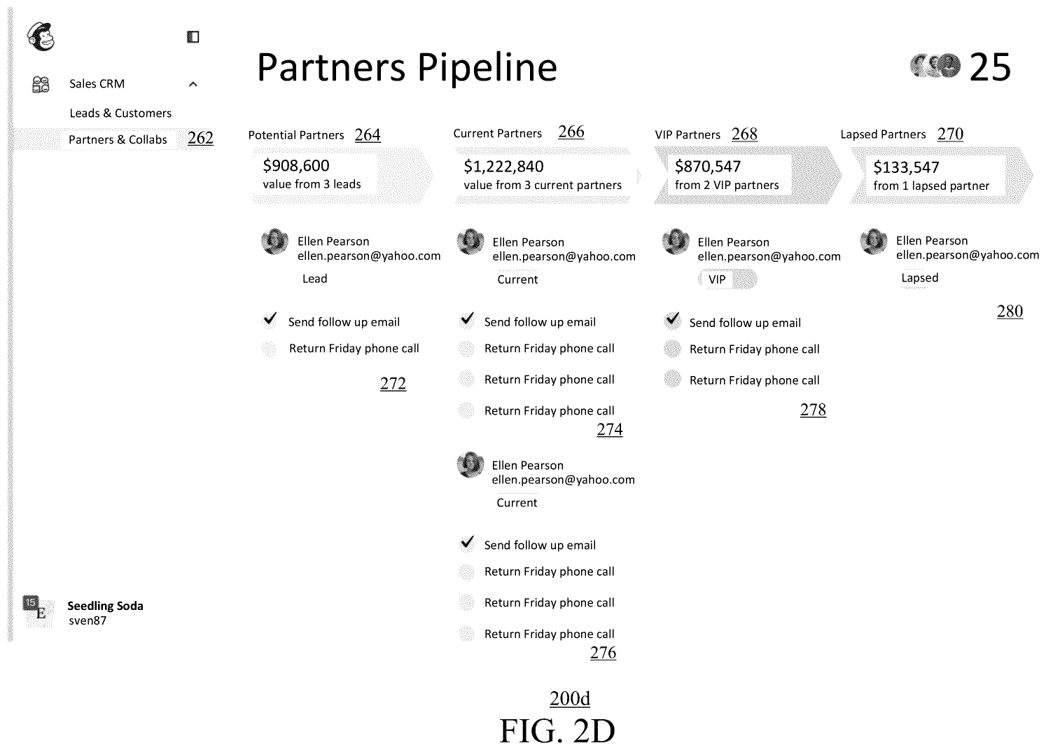

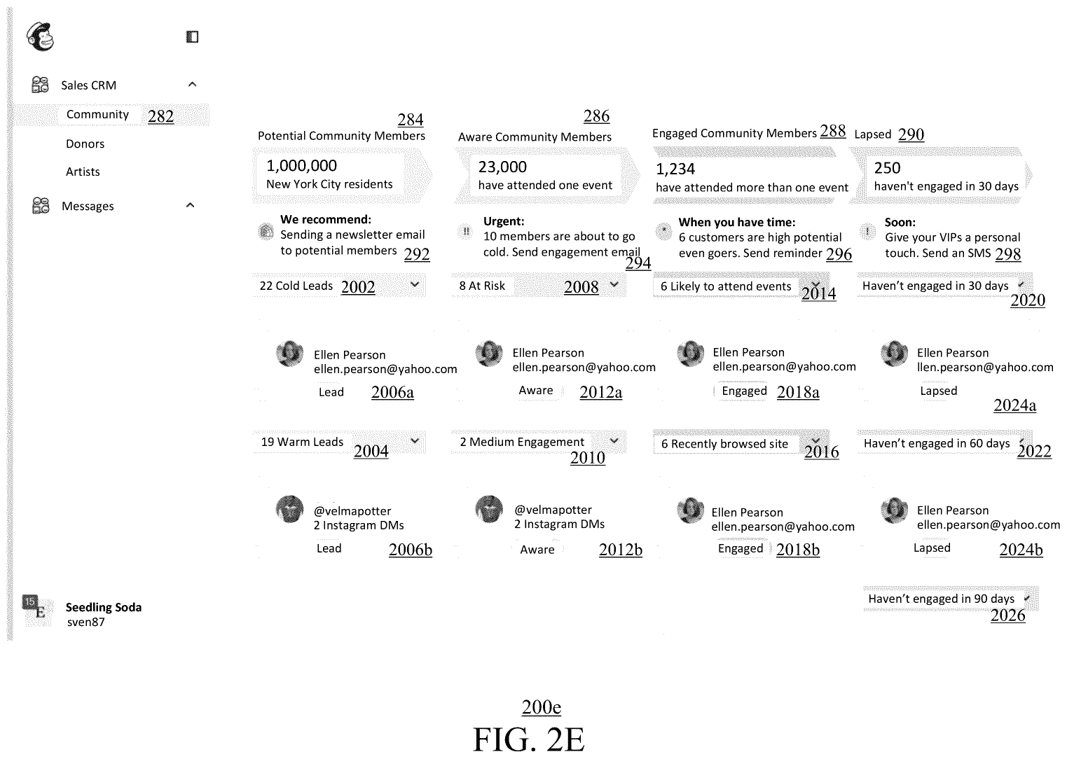

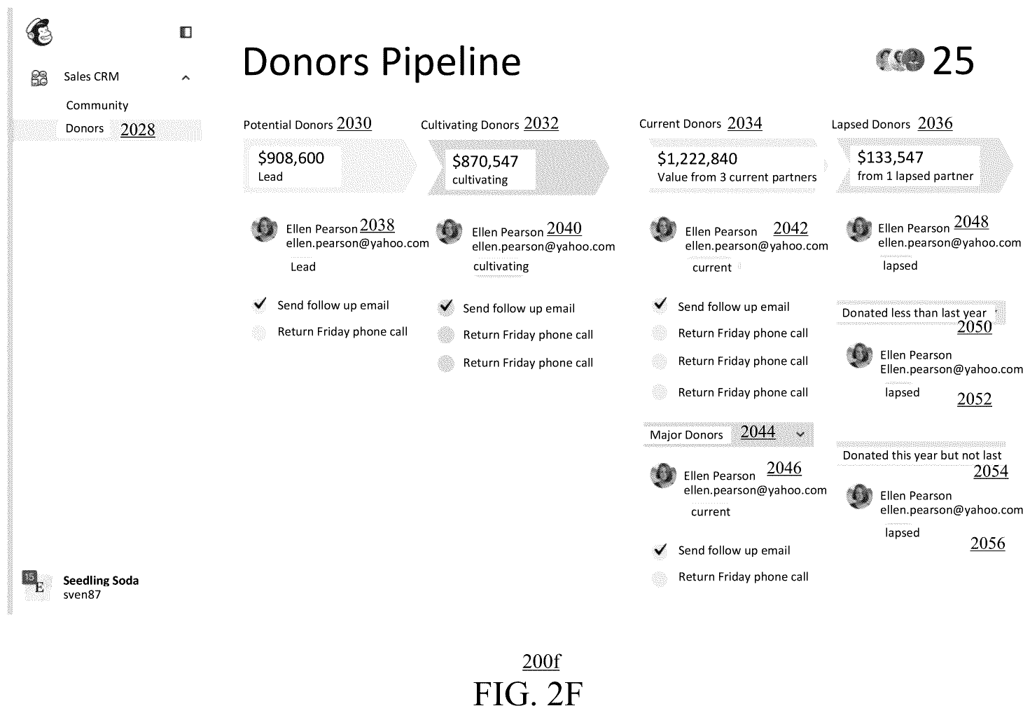

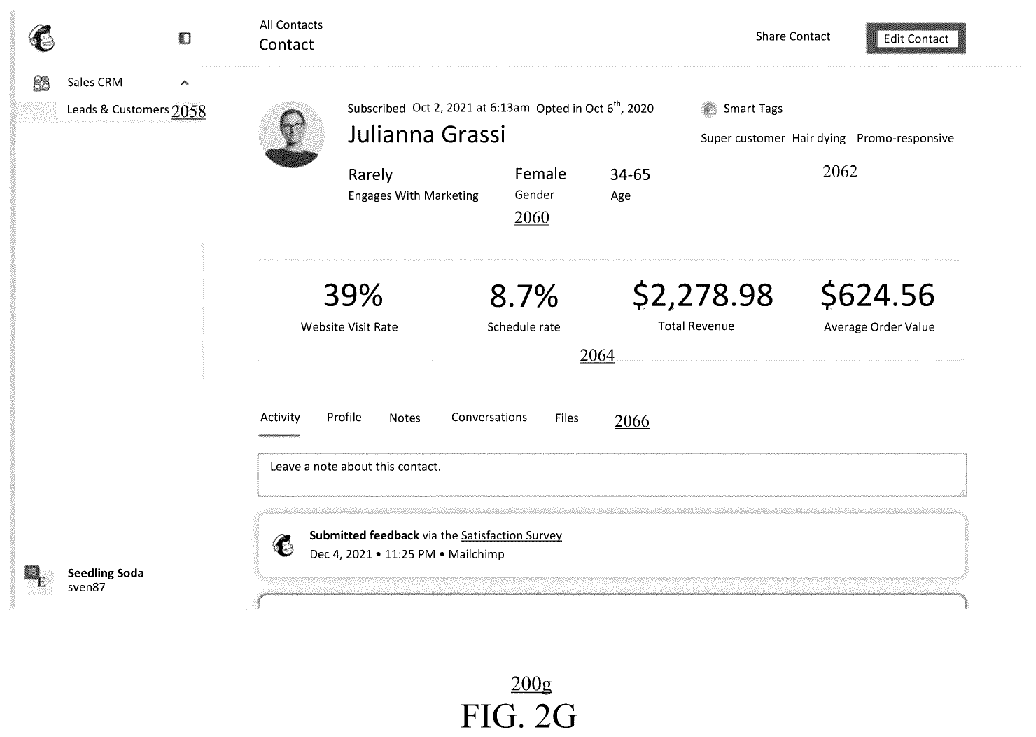

FIG. 2A shows an example GUI 200a generated by the CRM tool based on the principles disclosed herein. Particularly, the GUI 200a is generated to allow a user of the CRM tool to log into the CRM tool (the user may be an employee of a current entity deploying the CRM tool). To that end, the GUI 200a includes a username field 202, a password field 204, and page graphics 206. Once the user enters the correct login information in each of the username field 202 and the password field 204, the CRM tool allows the user to access the features described throughout this disclosure.

FIG. 2B shows an example GUI 200b generated by the CRM tool based on the principles disclosed herein. Particularly, GUI 200b allows the user to connect to other platforms to access customer information. As non-limiting examples, GUI 200b shows potential connections to a first platform 208 (“Instagram”) and a second platform 210 (“Shopify”). The customer information gained from connecting to these platforms (e.g., 208, 210) can include customer shopping and spending habits, customer preferences, customer demographics, and/or any other type of customer information.

FIG. 2C shows an example GUI 200c generated by the CRM tool based on the principles disclosed herein. Particularly, the GUI 200c is generated by the CRM tool when customer data is collected, e.g., through one or more connections to different platforms and/or collected through any other means. The GUI 200c provides a pipeline view of leads and customers 212 of the CRM tool. As shown, the pipeline view shows a leads phase 214, which includes information about probable customers; a perspective customers phase 216, which includes information about potential customers; an existing customers' phase 218, which includes information about existing customers; and a loyal customers phase 220, which includes information about repeat and loyal customers.

As shown, the leads phase 214 includes information about a number of leads (e.g., 41) and the potential value (e.g., $908,600) from the leads. The leads phase 214 further divides the leads into three sections: cold leads 230, warm leads 246, and lapsed leads 254. The cold leads 230 includes information about leads that may not have been approached by the CRM tool (e.g., no message has been sent to these leads). The cold leads 230 are generally generated by analyzing information received from one or more platforms, e.g., a first platform 208 and a second platform 210. One or more cold leads 230 are then transformed into warm leads 246 by driving some form of engagement. For example, the CRM tool engages the cold leads 230 through example means of communications, including but not limited to, telephone calls, e-mail messages, text messages, and/or any other form of communications. These cold leads (e.g., cold lead 238a) can be converted into warm leads 246 (e.g., warm lead 238b) through such engagements. Additionally, leads phase 214 further includes lapsed leads 254, e.g., leads that have not been responsive to one or more engagement messages from the CRM tool.

In addition to showing the information about cold leads 230, warm leads 246, and lapsed leads 254, the CRM tool further generates a recommended action 222 (e.g., by using one or more machine learning models) to proactively drive engagements in the leads phase 214. For example, the recommended action 222 may include sending a nurturing e-mail to inactive leads. An example of nurturing e-mail message may be, “How are you doing this fall season,” or “Happy birthday to you.” Generally, the nurturing messages are geared toward increasing the affinity of the leads to the current entity (i.e., the entity that has deployed the CRM tool). Therefore, the CRM tool not only displays information about different types of leads in the leads phase 214, but also proactively provides recommended actions (e.g., recommended action 222) to drive up the engagements with the leads.

The perspective customers phase 216 displays information about perspective customers. In the shown example, there are 50 perspective customers that have a potential value of $1,222,840. The perspective customers are divided into three categories: at risk perspective customers 232, medium engagement perspective customers 248, and low engagement perspective customers 256. The at risk perspective customers 232, e.g., perspective customer 240, includes information about perspective customers that may disengage with the entity. For example, these perspective customers may not have responded to a threshold number of engagement messages. The medium engagement perspective customers 240, e.g., perspective customer 240b, includes perspective customers that engage with a subset of the engagement messages. For instance, these perspective customers may have responded to a few, but not all, engagement messages. The low engagement perspective customers 256 include perspective customers that have responded to e.g., one or two engagement messages. These perspective customers, by being non-responsive most of the time, may carry a risk of going cold. To pre-empt the low engagement customers 256 (and/or the medium engagement perspective customers 248) from becoming at risk perspective customers, the CRM tool proactively generates (e.g., by using one or more machine learning models) a recommended action 224. For example, the recommended action 224 may include sending an engagement e-mail (e.g., an e-mail with a discount coupon) to the perspective customers that are about to go cold.

The existing customers phase 218 provides information about customers that have had recent transactions with the entity. In the shown example, there are twelve existing customers that have generated a value of $870,547. The existing customers are divided into three categories: likely repurchasers 234, customers that have recently browsed 250, customers that have lapsed 258. The likely repurchases 234, e.g., existing customer 242a, are determined by the CRM tool (e.g., based on the purchase habits) to have a potential of buying additional products and/or services. The customers that have recently browsed, e.g., existing customer 242b, includes existing customers that have browsed (e.g., on an e-commerce website associated with the entity) one or more products and/or services. The customers that have lapsed 258, e.g., customer 242c, includes customers that have not purchased anything e.g., in the past 30 days.

In addition to categorizing the different types of customers in the existing customer phase 218, the CRM tool may further generate (e.g., by using one or more machine learning models) a recommended action 226 for the existing customers. For instance, a recommended action 226 may include, “6 customers are likely to repurchase. Send reminder.” The recommended action 226 (and/or the recommended actions 222, 224) may include a hyperlink to perform the recommended action. For example, the “Send reminder” portion of the recommended action is hyperlinked to an e-mail, text, and/or a telephone platform to send the reminder.

The loyal customers phase 220 provides information about repeat or otherwise loyal customers. As shown, there are four loyal customers generating a value of $133,547. The loyal customers are divided into three example categories: high value loyal customers 236, VIP loyal customers 252, and lapsed loyal customers 260. The high value loyal customers 236, e.g., loyal customer 244a, includes customers that have over $2000 of spend with the entity. The VIP loyal customers 252, e.g., loyal customer 244b, include customers that have purchased products and/or services more than three times from the entity. The lapsed loyal customers 260 include customers that have reduced purchase amount and/or purchase numbers from the entity.

In addition to providing information about the loyal customers, the CRM provides a recommended action 228 for a further engagement with the loyal customers. An example recommended action 228 may include “Give your VIPs a personal touch. Send an SMS.” As with the above described recommended actions 222, 224, 226, the recommended action 228 provides a hyperlink to perform the recommended action 228. For example, the “Send an SMS” portion of the recommended action 228 includes a hyperlink to send the SMS message to the appropriate customers.

Therefore, the pipeline view in the illustrated GUI 200c enables a user to drive engagement with customers at any phase (lead, perspective, existing, and loyal). The pipeline view enables the user to see the statuses of the different phases. On top of this intuitive view, the pipeline view also proactively provides recommended actions to the user to further drive customer engagement.

FIG. 2D shows an example GUI 200d generated by the CRM tool based on the principles disclosed herein. Particularly, GUI 200d shows a pipeline view of partners and collaborators 262. That is, in contrast to customer pipeline view shown in GUI 200c, GUI 200d is configured to drive engagement with partners. For example, if the current entity using the CRM tool is an e-commerce merchant, the partners may include, for example, suppliers, manufacturers, logistics companies, etc. As opposed to lower priced but large volume transactions with multiple customers, the partners are generally involved in higher priced but few transactions (e.g., bulk orders of merchandise). Therefore, the number of partners being handled by the CRM tool is generally lower than the number of customers.

As shown, GUI 200d includes four example phases: potential partners phase 264, a current partners phase 266, a VIP partners phase 268, and lapsed partners phase 270. In addition to the phases, the GUI 200d may include tasks associated with the individual partners 272, 274, 276, 278, 280, which are at different phases of engagement.

The potential partners phase 264 includes leads information for entities that may be potential partners with the current entity. The potential partner data is generally gathered from on-line data, social media platforms, and/or any other type of source. As shown, the potential partners phase 264 includes three leads with a potential value of $908,600. In addition to the collective data, the illustrated GUI 200d shows information and tasks regarding an individual partner 272s in the potential partners phase 264. As shown, the tasks include, for example, “Send follow up e-mail,” and “Return Friday phone call.”

The current partners phase 266 includes information on the partners with ongoing relationship. As shown, there are three current partners with the value of $1,222,840. Furthermore, two individual partners 274, 276 that are in the current partners phase 266 are shown. Using the illustrated GUI 200d, a user can engage with the current partners 274, 276, for example, by selecting a software button to send a follow up e-mail.

The VIP partners phase 268 include partners that have a significant ongoing relationship with the current entity. As shown, there are 2 VIP partners generating a value of $870,547. In addition to the collective information, information on an individual VIP partner 278 is also shown. A user uses the shown information for the individual VIP partner 278 to drive further engagement, e.g., by sending a follow up e-mail. The lapsed partners phase 270 includes information about entities of which the partnership with the current entity has lapsed. As shown, there is one lapsed partner with the value of $133,547. The GUI 200d may allow an engagement with the lapsed partners with one or more tools, e.g., similar to those used in the other phases.

Therefore, GUI 200d allows a user to track the differing relationships with different partners. GUI 200d further provides a direct- and convenient-communication with these partners, e.g., by sending an e-mail or making a call directly from the GUI 200d. Additionally, the GUI 200d allows different tasks associated with different partners to be presented and tracked as to-do lists.

FIG. 2E shows an example GUI 200e generated by the CRM tool based on the principles disclosed herein. In particular, GUI 200e shows a pipeline view for community engagement 282. The community engagement 282 may not necessarily be for driving e-commerce transactions, but may be for a community organization supporting a cause, e.g., a non-profit organization. The pipeline view shows four example phases: a potential community members phase 285, an aware community members phase 286, an engaged community members phase 288, and a lapsed community members phase 290.

The potential community members phase 284 includes potential community members that may be interested in one or more community events (e.g., for the cause). As shown, the potential community members include one million New York City residents. The potential community members are organized into two example categories: cold leads 2002 (e.g., 22 in number) and warm leads 2004 (19 in number). A community member, e.g., 2006a, within the cold leads 2002 category may have a potential of attending the one or more events, but has not been sent an engagement message. A community member, e.g., 2006, within the warm leads 2004 category may have been sent an engagement message and/or may have responded to the engagement message. In addition to showing the categories, the potential community members phase 284 provides a recommended action 292. For instance, the recommended action 292 includes “Send a newsletter email to potential members.” The recommended action 292 has a hyperlink (e.g., to the e-mail server) to send the newsletter e-mail.

The aware community members phase 286 includes community members that are aware of the one or more events. As shown, this phase includes 23,000 community members that have attended one event. Some community members in this phase are divided into two example categories: an at risk category 2008 (containing 8 community members including member 2012a) and a medium engagement category 2010 (containing 2 members including member 2012b). Community members in these categories 2008, 2010 are at risk, and therefore the CRM provides a recommended action 294 to drive engagement with these community members. An example recommended action 294 may include “10 members are about to go cold. Send engagement e-mail.” A portion of the recommended action 294 is generally hyperlinked (e.g., to an e-mail client in this case) such that the user can directly perform the action from the illustrated GUI 200e.

The engaged community members phase 288 includes community members that have attended more than one event. As shown, there are 1,234 community members in this phase. Some community members in this phase are divided into two example categories: likely to attend events category 2014 (having six members including member 2018a) and recently browsed site category 2016 (having 6 members including member 2018b). In addition to showing such categorization, the GUI 200e also provides a recommended action 296 to engage with community members at this phase. For example, a recommended action 296 may be “6 members are high potential event goers. Send reminder.” A portion of the recommended action 296 includes a hyperlink to perform the recommended action 296 directly from the illustrated GUI 200e.

The lapsed community members phase 290 includes community members that have not engaged in the past 30 days. As shown, there are 250 community members in this phase. Some community members in this phase are divided into three example categories: a first category 2020 of community members (including community member 2024a) that have not engaged in the past 30 days, a second category 2022 of community members (including community member 2024b) that have not engaged in the past 60 days, and a third category 2026 of community members that have not engaged in the past 90 days. In addition to the categorization, the illustrated GUI 200e provides a recommended action 298 to engage with the lapsed community members. For example, the recommended action 298 may include, “Send an SMS to the lapsed members.” A portion of the recommended action 298 has a hyperlink such that the user can perform the recommended action 298 directly from the GUI 200e.

FIG. 2F shows an example GUI 200f generated by the CRM tool based on the principles disclosed herein. The GUI 200f shows a pipeline view for donors 2028, i.e., people/entities that are solicited for donations to the current entity. As shown, the pipeline view for donors 2028 includes four example phases: a potential donors phase 2030, a cultivating donors phase 2032, a current donors phase 2034, and a lapsed donor phase 2036. In additional to these phases, the example GUI 200f also shows individual customers 2038, 2040, 2042, 2046, 2048, 2052, 2056, belonging to different phases.

The potential donors phase 2030 includes people/entities that could potentially donate to the current entity. As shown, the potential value for these potential donors is $908,600. An individual donor 2038 is shown too, along with the different tasks that can be performed directly from the GUI 200f to engage the individual donor 2038. An example task includes “Send follow up email.”

The cultivating donors phase 2032 includes information about donors that are being engaged/cultivated to donate to the current entity. As shown, the potential value that may be provided by the donors at this phase is $870,547. An individual donor 2040 that is being cultivated is shown as well. In addition to the information about the individual donor 2040, the example GUI 200f shows one or more tasks that can be done directly to further engage with the donor 2040. An example task includes “Send follow up e-mail.”

The current donors phase 2034 includes information about the current donors to the current entity. As shown, the value provided by the current donors is $1,222,840. Furthermore, information about individual donors 2042, 2046 and different tasks that can be performed using the GUI 200f are shown as well. An example task includes “Send follow up e-mail.” Additionally, a category may be defined within this phase. An example category includes major donors 2044 that includes the individual donor 2046.

The lapsed donors phase 2036 includes information about donors that have contributed in the past, but have currently stopped contributing. As shown, the potential value from the lapsed donors is $133,547. Within this phase, information about three individual lapsed donors 2048, 2052, 2056 is shown. Furthermore, the donors in this phase may be categorized into example categories such as the donated less than last year category 2050 (containing individual donor 2052), donated this year but not last category 2054 (containing individual donor 2056), etc.

Therefore, the illustrated GUI 200f may help the current entity solicit, engage, and otherwise keep track of its donors. Additionally, the illustrated GUI 200f may help the entity to re-engage with lapsed donors.

FIG. 2G shows an example GUI 200g generated by the CRM tool based on the principles disclosed herein. Particularly, GUI 200g shows information about an individual lead or customer 2058. Such individual may be a customer, a community member, and/or a donor. Furthermore, the GUI 200g is generated when the user selects an individual information selector shown in the above GUIs. Therefore, there is a seamless integration between different GUIs showing the pipeline view and the individual customer view.

The individual customer view shown by the example GUI 200g includes demographic information 2060 of the customer. The illustrated demographic information 2060 includes the name, date of access/subscription to the CRM tool, level of engagement with CRM tool (e.g., “rarely”), gender, age, etc. The illustrated GUI 200g further includes smart tags 2062 generated for the individual. The smart tags are generally searchable and allow categorization of customers. For instance, the customer shown in the GUI 200g is tagged as “super customer,” “hair dying,” and “promo-responsive.”

Additionally, the example GUI 200g shows statistics 2064 associated with the customer. The statistics 2064 includes, for example, website visit rate, schedule rate, total revenue, and average order value. The statistics 2064 therefore provides a consolidated view of the value provided by the customers. Furthermore, the GUI 200g shows activity information 2066 associated with the customer. The activity 2066 may include recent activity by the customer (e.g., “submitted feedback”), profile activity of the customer, notes associated with the customer, conversations associated with the customer, files associated with the customer, etc.

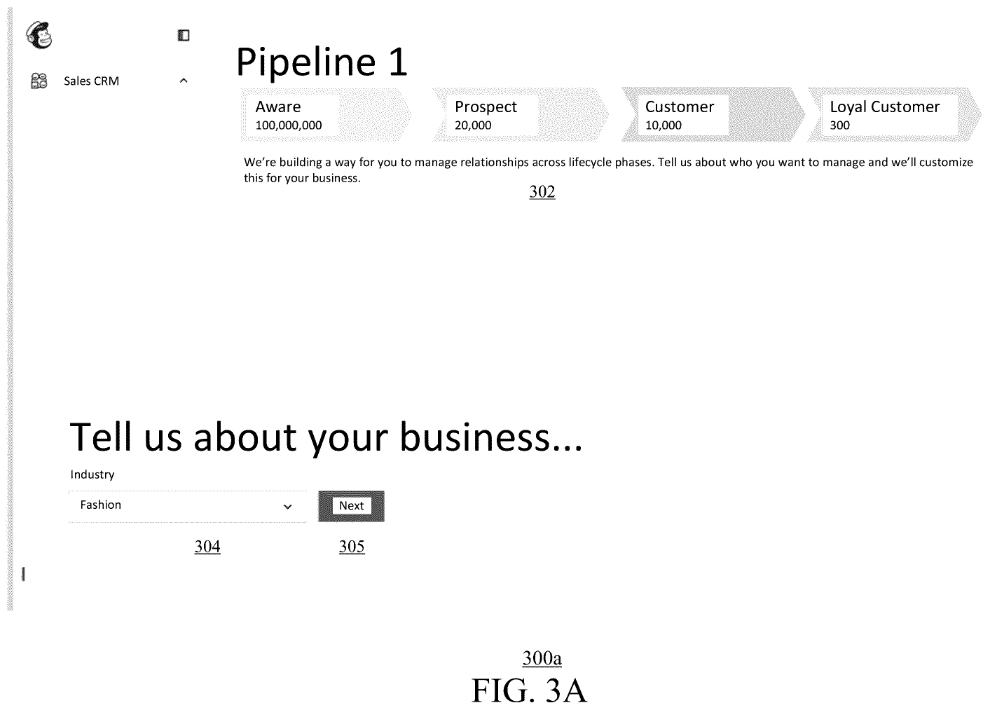

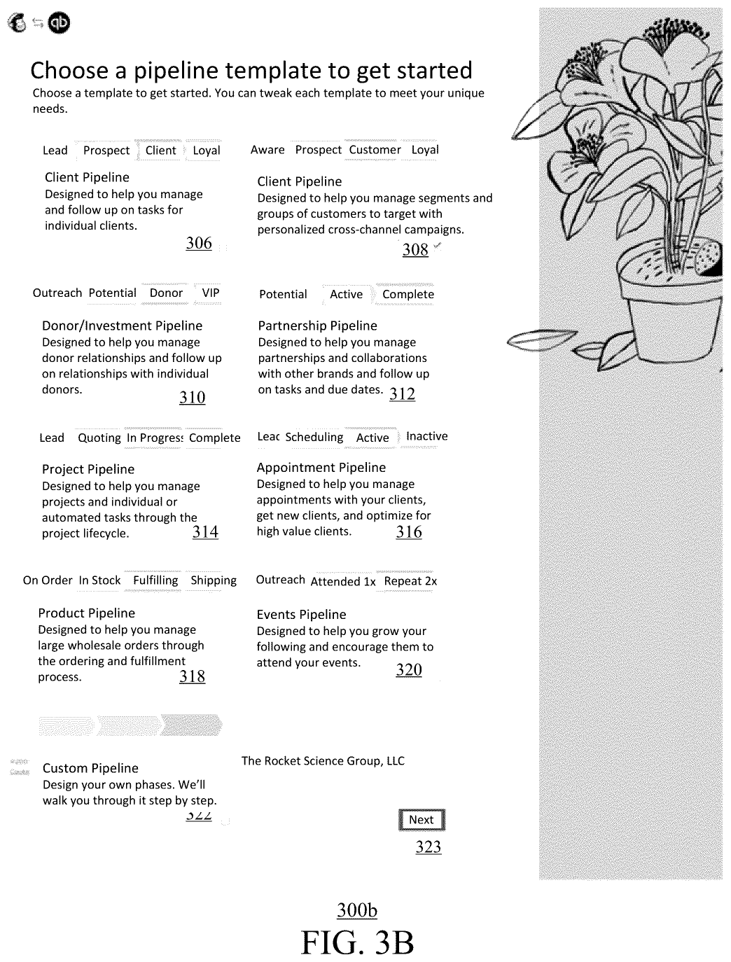

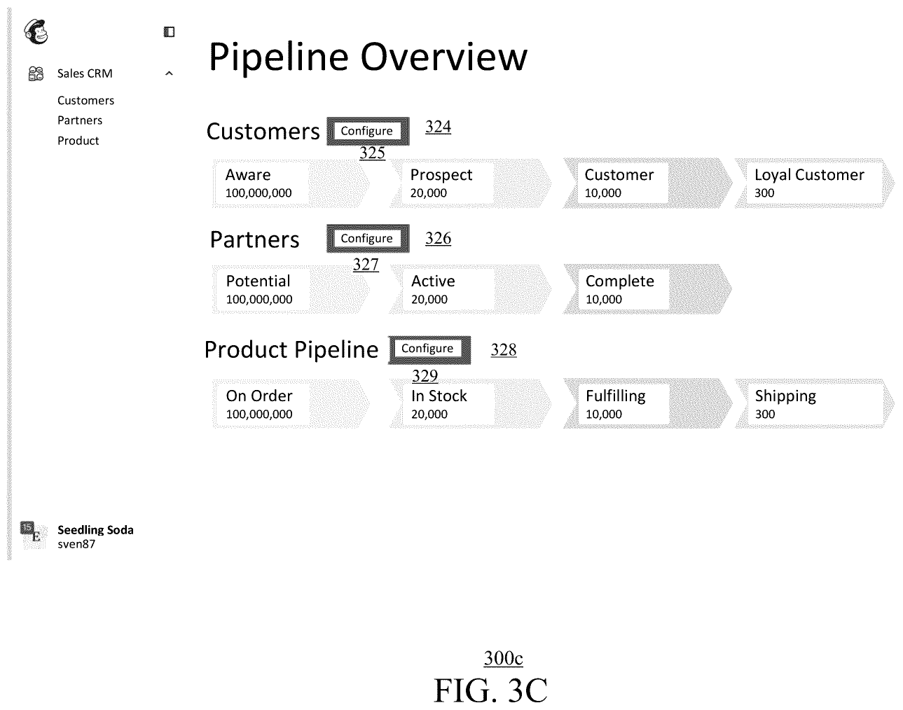

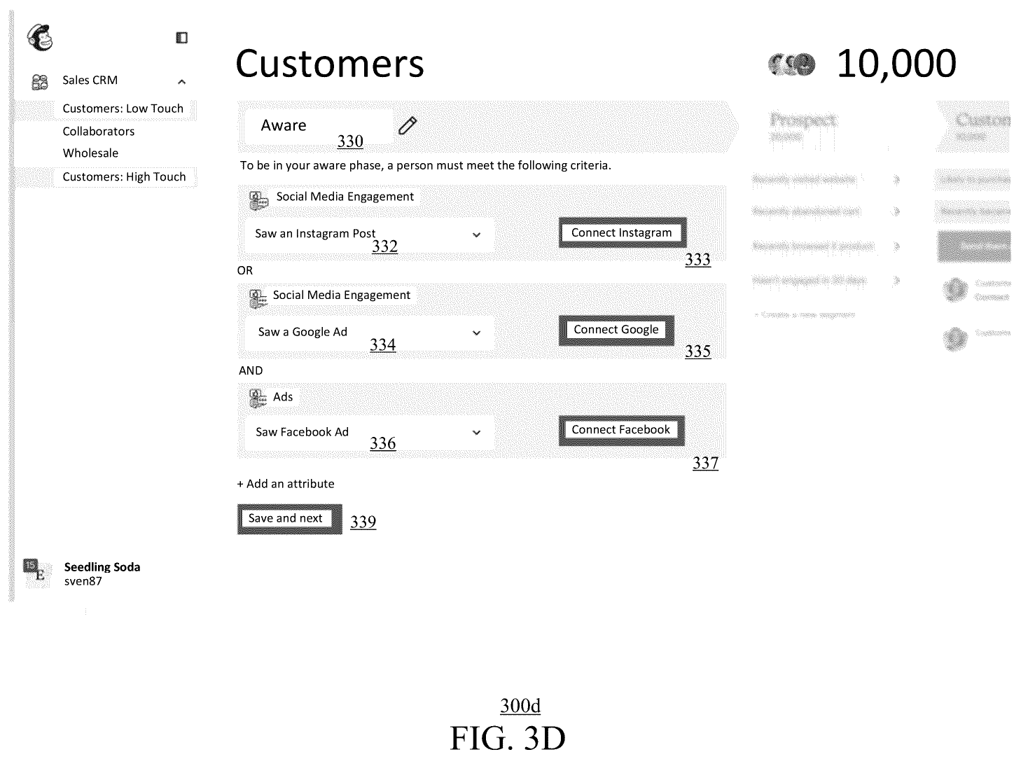

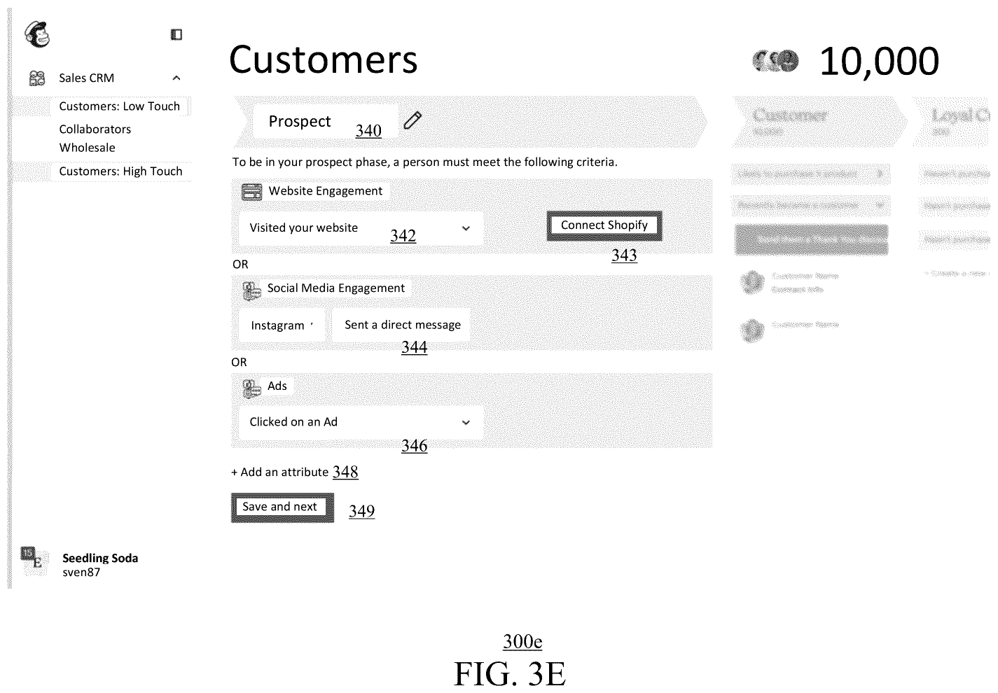

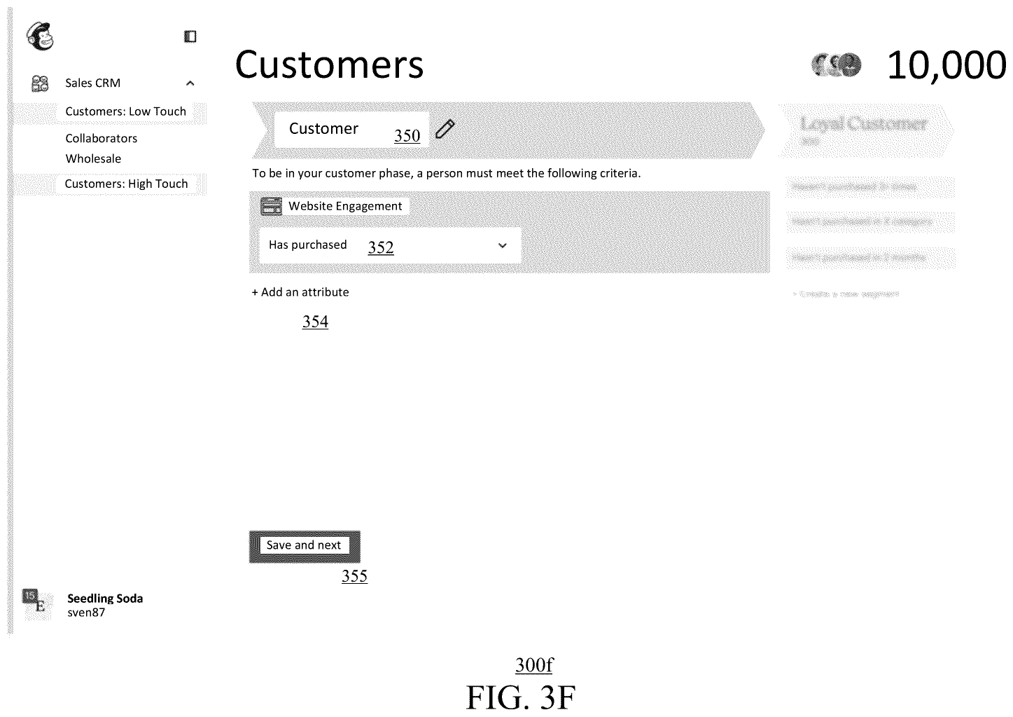

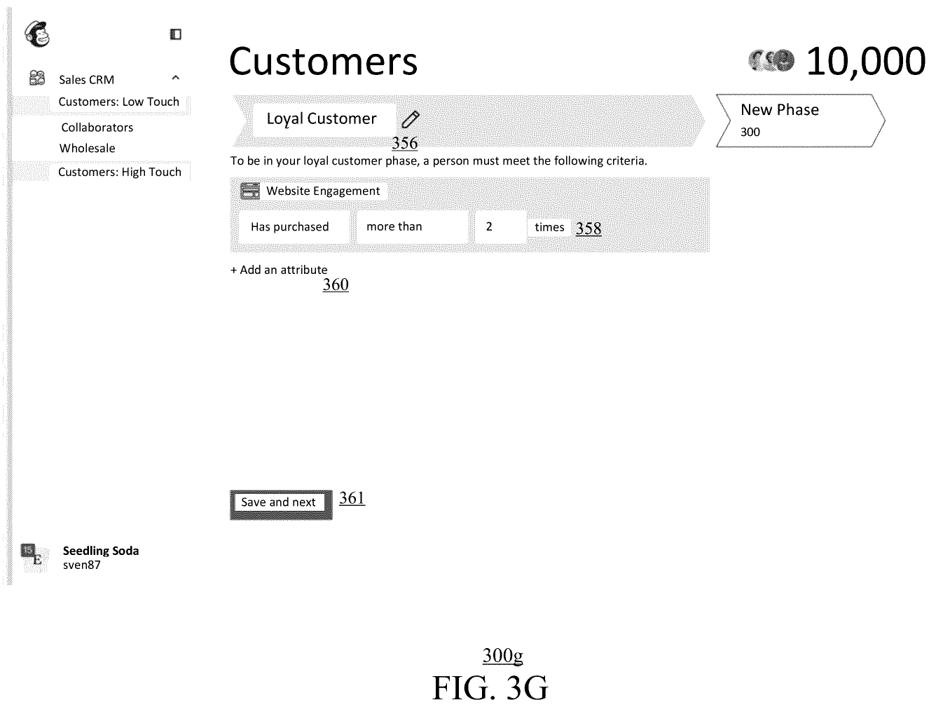

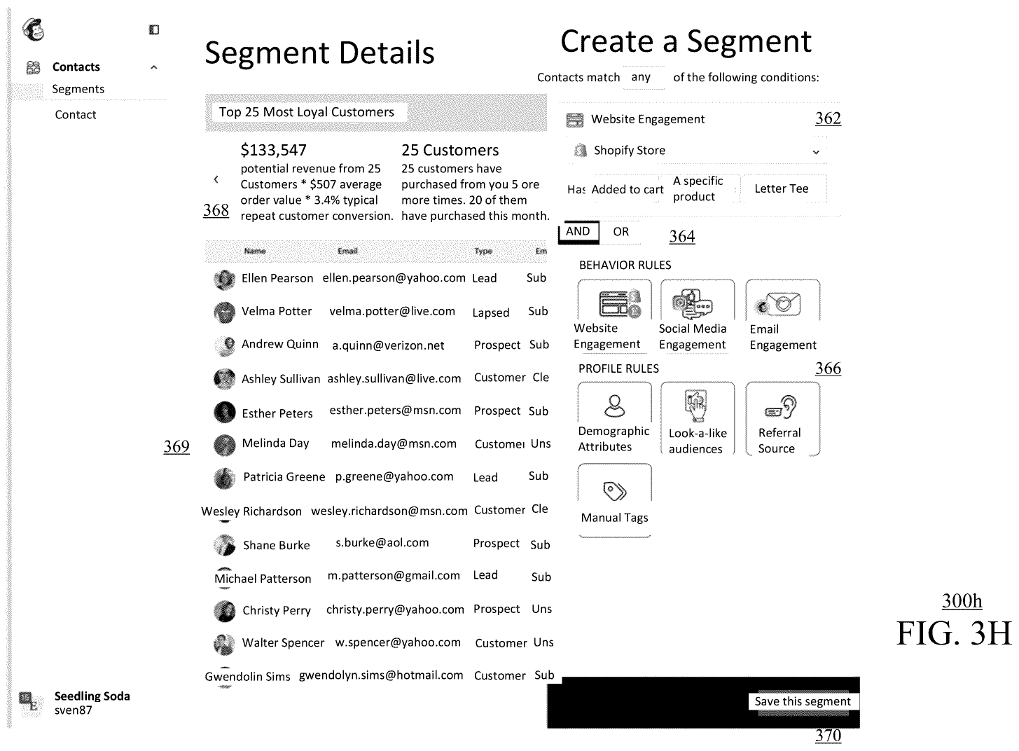

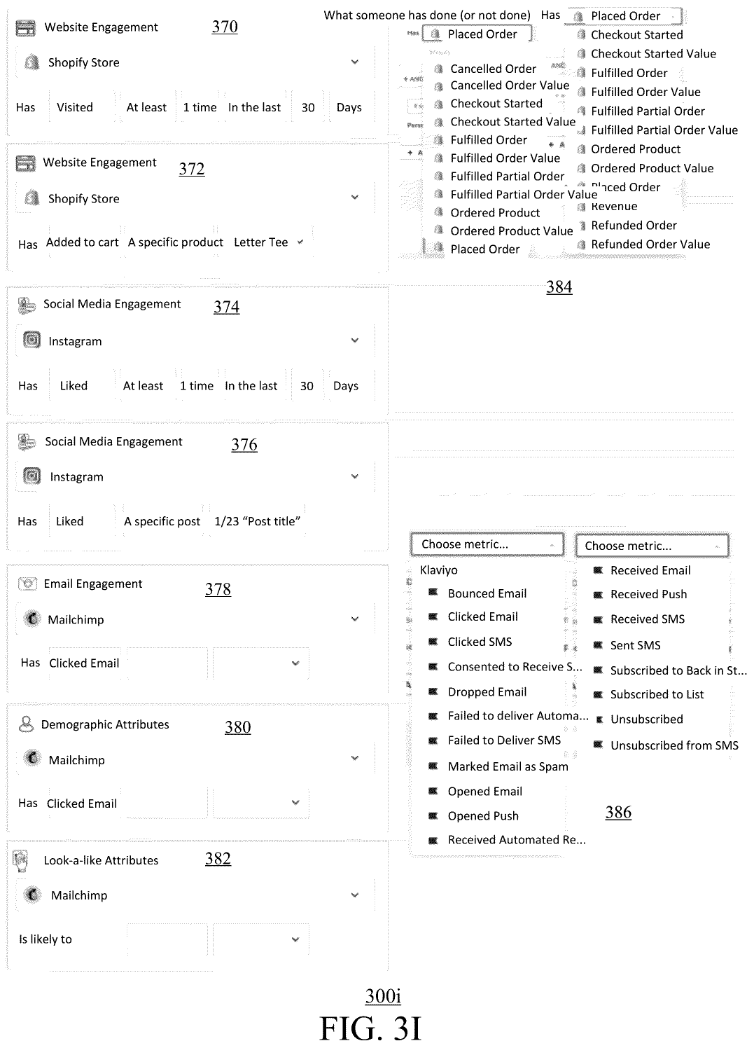

FIG. 3A shows an example GUI 300a generated by the CRM tool based on the principles disclosed herein. The GUI 300a is generated when a user intends to a define a pipeline (e.g., pipelines described with reference to FIGS. 2A-2G above). Particularly, the example GUI 300a shows an initial page for an example pipeline 302 and a text box 304 to enter the user's type of business. The user then selects the “next” button 305.

FIG. 3B shows an example GUI 300b generated by the CRM tool, based on the principles disclosed herein. GUI 300b is generated when the user enters the type of business in the text box 304 and selects the “next” button 305 displayed in GUI 300a. GUI 300b allows the user to select from different pipeline templates. Some example templates include, for example, a client pipeline 306, customer pipelines 308, donor/investor pipeline 310, project pipeline 314, an appointment pipeline 316, a product pipeline 318, an events pipeline 320, a custom pipeline line 322, etc. The user may select any of these pipelines (i.e., pipeline templates) and select the “next” button 323.

FIG. 3C shows an example GUI 300c generated by the CRM tool based on the principles disclosed herein. Particularly, the GUI 300c is generated when the user selects one or more pipelines displayed in GUI 300b and then selects the “next” button 323. GUI 300c allows a configuration of the selected pipelines. As shown, GUI 300c includes a configurable customers pipeline 324 (including aware, prospect, customer, and loyal customer phases), a configurable partners pipeline 326 (including potential, active, and complete phases), and a configurable product pipeline 328 (including on order, in stock, fulfilling, and shipping phases). Furthermore, the user can configure the customers pipeline 324 by selecting the “configure” button 325, partners pipeline 326 by selecting “configure” button 327, and product pipeline 328 by selecting the “configure” button 328. The CRM tool generates a corresponding GUI based on which one of the “configure” buttons 325, 327, 329 is selected.

FIG. 3D shows an example GUI 330d generated by the CRM tool based on the principles disclosed herein. Particularly, GUI 300d is generated when the user selects “configure” button 328 to configure the customers pipeline 324 in GUI 300c. Once the “configure” button 328 is selected, GUI 300d allows the user to configure the aware phase 330 of the customers pipeline 324. The CRM can impose—and the illustrated GUI 300d reflects—how a customer can be within the aware phase 330. For instance, the customer is eligible if there has been a social media engagement. The user can select using such social media involvement using a first drop down menu 332 (“Saw an Instagram Post”) and selecting a “Connect Instagram” button 333 to connect the CRM tool with the Instagram post. Alternatively, the user can use a second drop down menu 334 (“Saw a Google Ad”) and select “Connect to Google” button 335 to connect the CRM with the Google advertisement. Additionally, the user can select from a third drop down menu 336 (“Saw Facebook Ad”) and select “Connect to Facebook” button 337 to connect the CRM to the Facebook advertisement. In general, the GUI 300d is used to keep track of persons that are aware of a product and/or service supported by the CRM tool. The awareness, as described above, can come from the persons that have seen social media posts, advertisements, and/or any other digital or non-digital sources. Once all the selections have been made, the user selects the “save and next” button 339 to configure the next phase.

FIG. 3E shows an example GUI 300e generated by the CRM tool based on the principles disclosed herein. Particularly, GUI 300e is generated when the user selects the “save and next” button 339 in the GUI 300d. As shown, the GUI 300e is used to configure the prospect phase 340 of the customers pipeline. Persons belonging to the prospect phase 340 may have to have some form of engagement with a social media post and/or advertisement. For example, such engagement can be indicated by selecting from a first drop down menu 342 (“Visited your website”) and selecting the “Connect Shopify” button 343. Another alternate engagement can be indicated by selecting from a second drop down menu 344 (“Sent a direct message [on Instagram]”) to indicate that the person sent a direct message on a social media platform. Yet another alternate engagement can be indicated by selecting from a third drop down menu 346 (“Clicked on an Ad”) to indicate that the person clicked on a displayed advertisement. The user can also add other attributes of the person's engagement by selecting “Add an attribute” option 348. Once all the selections and configurations are made, the user selects “Save and next” button 349 to configure the next phase of the customers pipeline.

FIG. 3F shows an example GUI 300f generated by the CRM tool based on the principles disclosed herein. Particularly, GUI 300f is generated when the user selects the “Save and next” button 349 in the previous GUI 300e. As shown, the GUI 300f allows the user to configure to customer phase 350 of the customers pipeline. One of the conditions that the CRM tool can impose for persons to qualify for this phase is whether there has been a website engagement and/or purchase activity. The user may indicate the purchase activity by using a drop down menu 352 (“Has purchased [on the website]”). Additionally, the user can enter additional attributes by selecting the “Add an attribute” option 354. Once all the attributes have been defined and the desired configuration has been made, the user selects the “Save and next” button 355 to move on to the next phase.

FIG. 3G shows an example GUI 300g generated by the CRM tool based on the principles disclosed herein. Particularly, GUI 300g is generated when the user selects “Save and next” button 355 in the previous GUI 300f. As shown, GUI 300g allows the user to configure the “Loyal Customer” phase 356 of the pipeline. To that end, CRM may impose (and/or the user may define) one or more conditions for a person to quality as a loyal customer. For instance, the user can select from a set of dropdown menus 358 to indicate that a person in the loyal customer phase 356 should have purchased more than two times from the website. Additionally, GUI 300g allows selection of “Add an attribute” option 360. Once all the configuration is done, the user can select “Select and next” button 361 to configure a next phase, if any.

FIG. 3H shows an example GUI 300h generated by the CRM tool based on the principles disclosed herein. Particularly, GUI 300h is generated to allow the user to create a segment. As shown, a first condition 362 for creating a segment is whether customers have engagement with the website of the current entity. For example, the first condition 362 includes the option of selecting customers that have added a specific product to a shopping cart. A second condition 366 is based on other rules, e.g., social media engagement. The first and second conditions, as shown herein, are conjunctive (labeled as 364). The customers are selected from top 25 most loyal customers (group labeled as 368 and individuals labeled as 369). Once all the selections and condition definitions are performed, the user selects “save this segment” button 370 to configure a next phase, if any.

FIG. 3I shows an example GUI 300i generated by the CRM tool based on the principles disclosed herein. Particularly, GUI 300i is generated for the user to fine-tune a segment with multiple selections, options, and conditions shown in the illustrated example. To fine-tune a segment, the user can select from, for example, website engagements 370, 372, social media engagements 374, 376, email engagement 378, demographic attributes 380, look-alike attributes 382, and/or the like. Furthermore, the user can specify other conditions using the drop down menus 384, 386.

Therefore, one or more embodiments disclosed herein provide readily available templates and interfaces for a non-sophisticated user to easily configure a CRM tool. In other words, the CRM tool can be easily configured through normal computer usage skills, without requiring sophisticated computer programming skills, unlike the conventional systems.

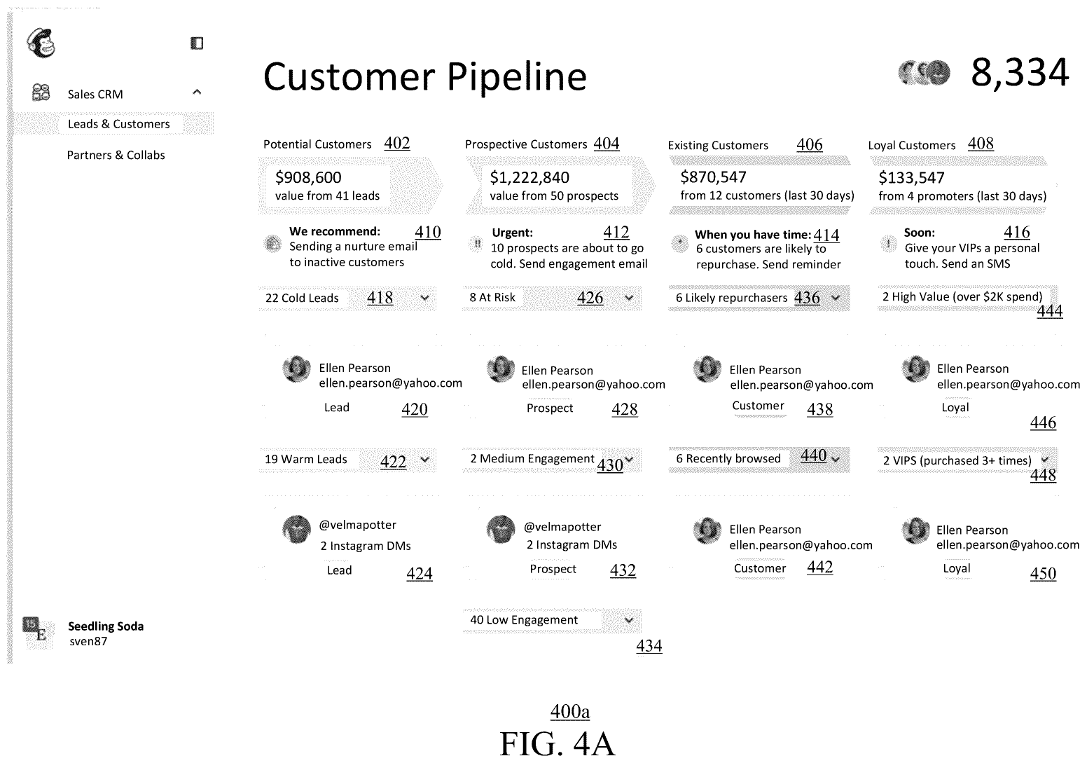

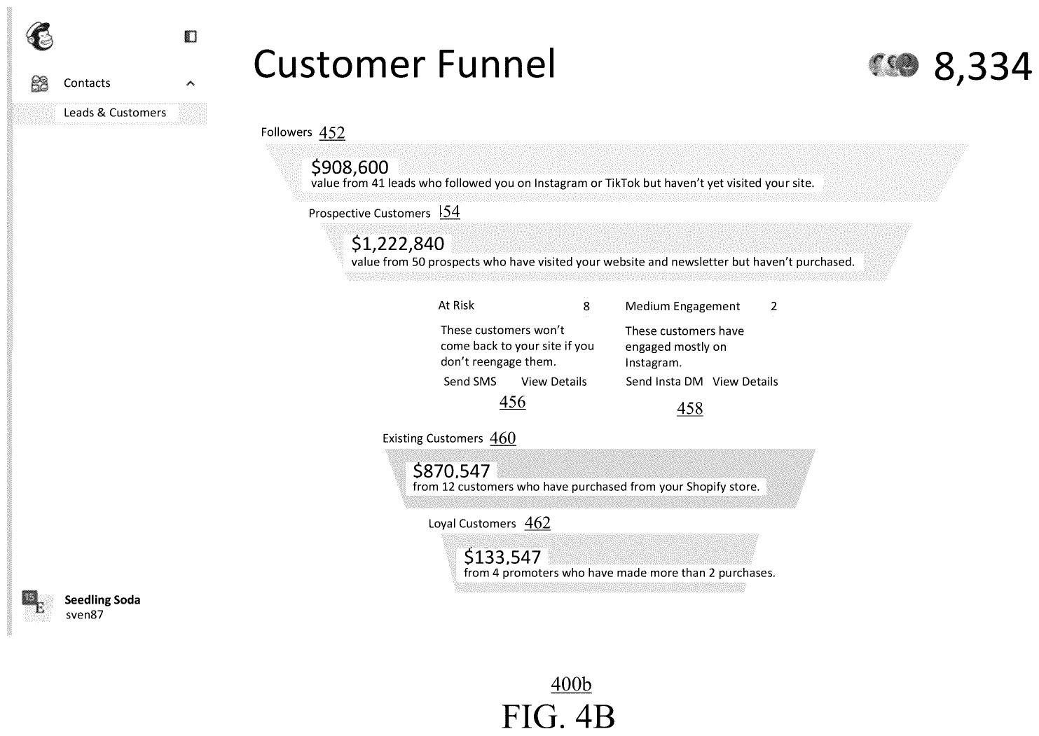

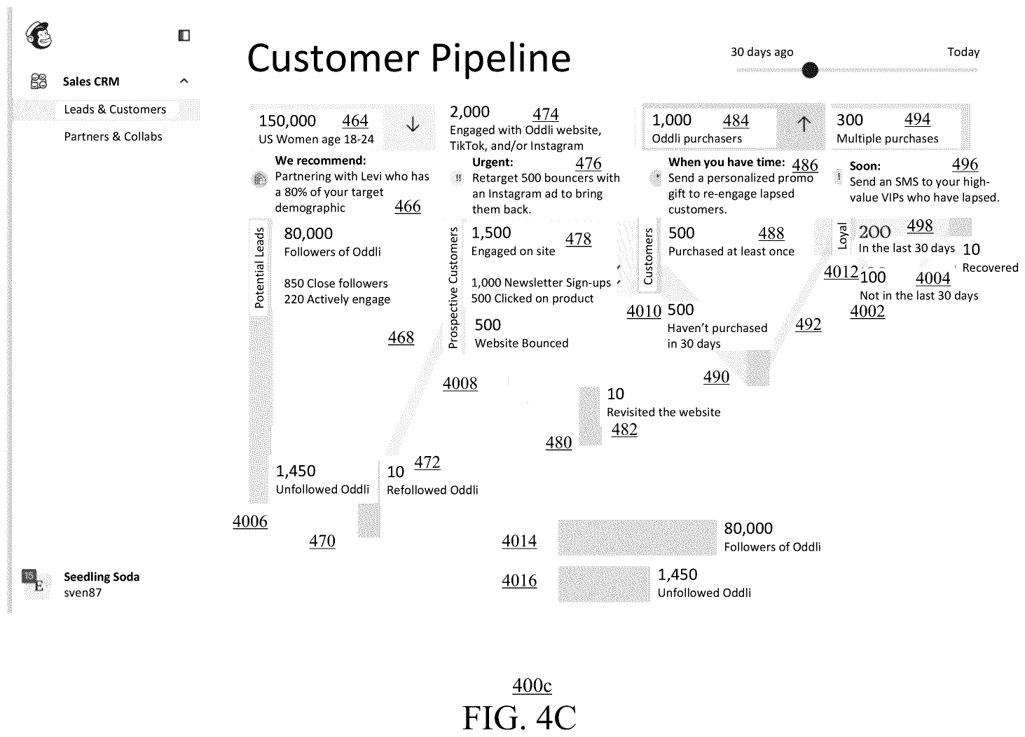

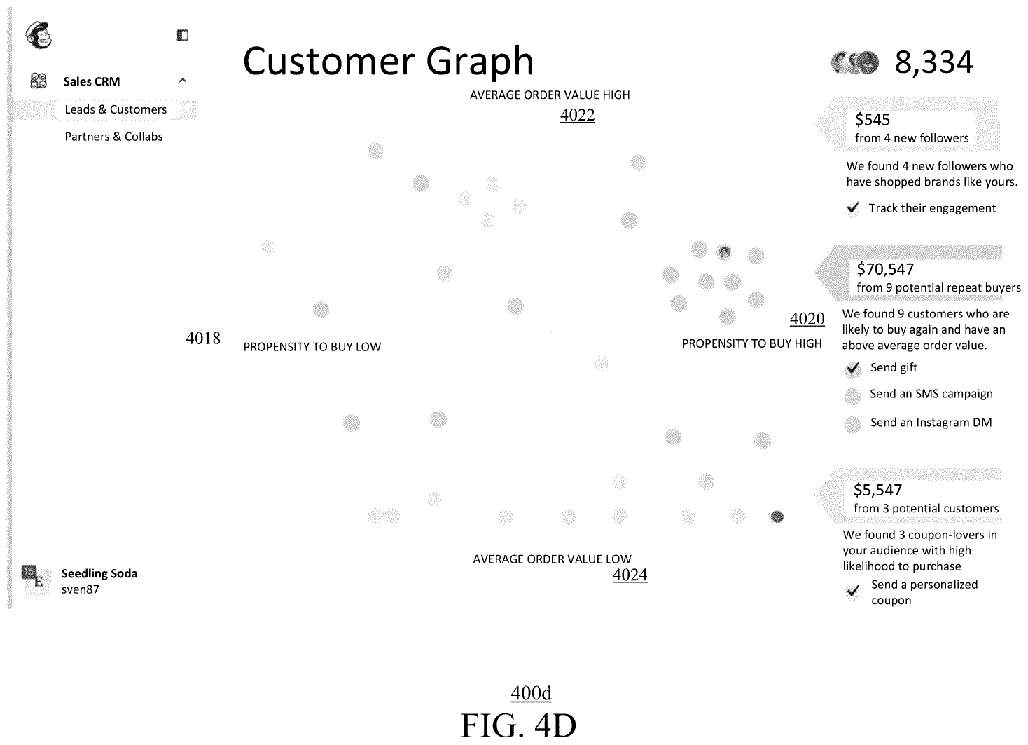

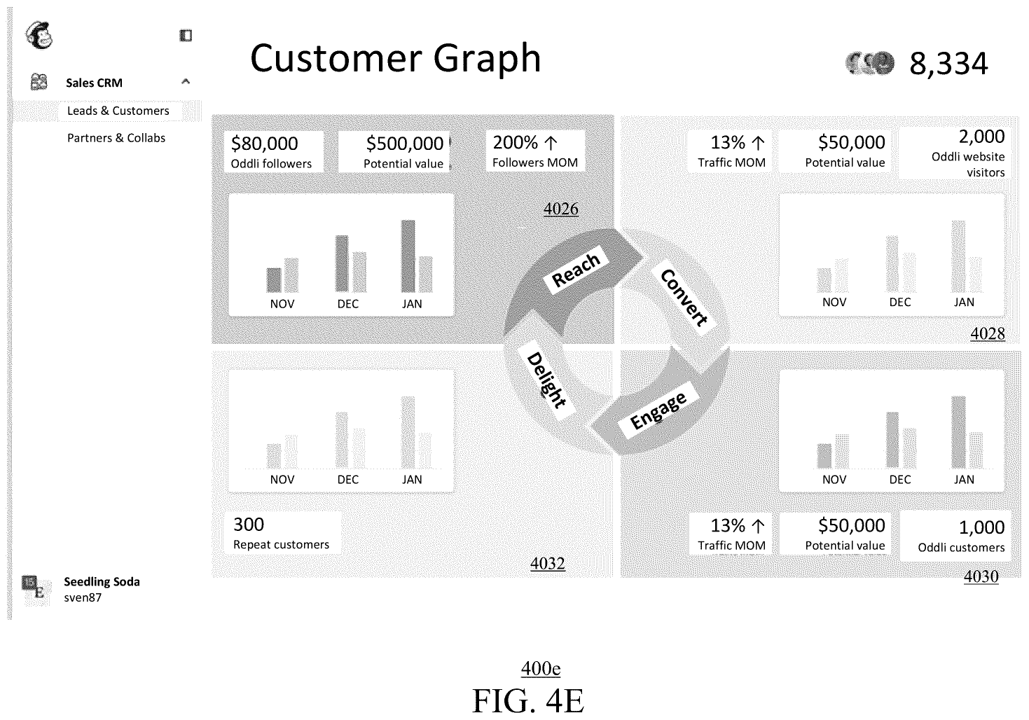

When these configured pipelines are used, the CRM provides multiple recommendations and options to increase the loyal customer base. Furthermore, actions to be taken and the rationales thereof are provided in an intuitive way for the user to grasp readily. Example GUIs that illustrate these principles are described below with reference to FIGS. 4A-4E.

FIG. 4A shows an example GUI 400a generated by the CRM tool based on the principles disclosed herein. Particularly GUI 400a shows a customer pipeline view with four example phases: prospective customers phases 402, 404, an existing customers phase 406, and a loyal customers phase 408. The first prospective customers phase 402 corresponds to customers that are aware of the product and the second prospective customers phase 404 corresponds to customers that have had some form of engagement. In the first prospective customers phase 402, there is a segmentation between cold leads 418 (containing a customer 420) and warm leads 422 (containing a customer 424). Additionally, there is a recommendation 410 to send a nurturing e-mail to inactive customers.

The second prospective customers phase 404 is segmented into an at risk 426 (containing customer 428), medium engagement 430 (containing customer 432), and low engagement 434. Additionally, an urgent message 412 is displayed to indicate to the user that some prospects are about to go cold and a free sample/product needs to be sent. The existing customers phase 406 is segmented into likely repurchasers 436 (containing customer 438) and recently browsed 440 (containing customer 442) categories. In addition, a recommendation 414 is displayed to indicate to the user that some customers in this phase are likely to repurchase one or more products/services and therefore a reminder is to be sent. Loyal customers phase 408 is segmented into a high value segment 444 with customers having more than $2,000 spend (containing customer 446) and a VIP segment 448 (containing customer 450). Additionally, a recommendation message 416 may be displayed to indicate to the user that the VIP users (e.g., within the VIP segment 448) are to be given a special touch and that a SMS message is recommended.

FIG. 4B shows an example GUI 400b generated by the CRM tool based on the principles disclosed herein. GUI 400b shows an alternate view (a customer funnel view) of the customer pipeline view shown in GUI 400a. As shown, the followers level 452 is mapped to the perspective customers phase 402 (of FIG. XX). The followers level 452 shows a potential value of $908,600 of 41 leads that followed the current entity on Instagram or TikTok but not have yet visited the current entity's website. The perspective customers level 454 is mapped to the perspective customers phase 404 (of FIG. 4A). The perspective customers level 454 shows a potential value of $1,222,840 of 50 prospects who have visited the current entity's website and/or accessed the newsletter but haven't purchased any product. The customers within this level are further segmented to at risk segment 456 and medium engagement segment 458. A recommendation to send an SMS is provided for the at risk segment with customers who may not come back to the website if a proactive reengagement (e.g., through SMS) is done. A recommendation to send an Instagram direct message is provided for the medium engagement segment 458 as these customers have been engaged mostly on Instagram.

The existing customers level 460 maps to the existing customers phase 406 (of FIG. 4A). As shown, the value at this level is $870,547 from 12 customers who have purchased from the current entity's store. The loyal customers level 462 maps into the loyal customers phase 408. As shown, the value at this level is $133,547 from 4 promoters who have made more than 2 purchases. The GUI 400b therefore shows how followers are ultimately “funneled” into loyal customers based on different proactive actions/recommendations suggested by the CRM tool.

FIG. 4C shows an example GUI 400c generated by the CRM tool based on the principles disclosed herein. The GUI 400c particularly shows a pipeline view illustrating a flow of customers between different phases and the engagement of these customers with the current entity. The shown use case begins with a target demographic 464 for the current entity, where the target demographic 464 includes 150,000 US women between ages 18-24. A recommendation 466 is provided in the GUI 400c indicating a partnership with another entity is recommended where that entity has 80% of the target demographic. The potential leads 4006 are selected from the target demographic 464. Out of the total number 150,000 in the target demographic, there are 80,000 followers (labeled as 468) of the current entity (out of which 580 are close followers and 220 actively engage). Furthermore, 1,450 followers (labeled as 470) have unfollowed the current entity. Out of these followers 470, 10 followers (labeled as 472) have refollowed the current entity. All of this analysis yields 2,000 customers (labeled as 474) as perspective customers 4008. The perspective customers 4008 have engaged with the current entity's website, TikTok, and/or Instagram. Out of 2000 perspective customers, 1500 customers (labeled as 478) have engaged on site (i.e., 1000 sign-ups and 500 product clicks), however, website bounced for 500 perspective customers (labeled as 480). In response, an urgent message 476 is generated to retarget the 500 bouncers with an Instagram ad to bring them back. Out of the bouncers 480, 10 perspective customers (labeled as 482) revisited the website. All these steps have generated 1000 purchasers (labeled as 484, 4010). Out of these 1000 customers, 500 customers (labeled as 488) have purchased a product at least once and 500 customers (labeled as 490) have not purchased in 30 days. Based on these statistics, a recommendation 486 is generated, wherein the recommendation 486 encourages the user send a personalized promotional gift to re-engage the lapsed customers 490 (i.e., the customers who have not purchased in the past 30 days). This personalized promotion gift brings back some customers (labeled as 492) back to being purchasing customers.

As a result, there are 300 loyal customers (labeled as 494,4012) that have made multiple purchases. Out of the loyal customers 4012, 200 customers (labeled as 498) have been seen in the last 30 days, and 100 customers (labeled as 4002) have not been seen in the last 30 days. Accordingly, a recommendation 496 may be generated to send an SMS to the lapsed customers 4002, some of which are recovered (recovered customers labeled as 4004) in response to the recommendation 496. The GUI 400c further shows the overall statistic that there are 80,000 followers (labeled as 4014) of the current entity while 1,450 persons (labeled as 4016) have unfollowed the current entity.

Therefore, the GUI 400c allows a user to have an intuitive pipeline view of customers with differing levels of engagement. Furthermore, the pipeline view allows the user to assess the impact of different recommended actions, i.e., how many customers changed their behavior when the corresponding recommended actions were performed.

FIG. 4D shows an example GUI 400d generated by the CRM tool based on the principles disclosed herein. The GUI 400d shows a customer graph view where the customers are segmented along two axes: propensity to buy—from a low propensity to buy 4018 to a high propensity to buy 4020, and average order value—from a low average order value 4024 to a high average order value 4022. The GUI 400d therefore shows an overall status of different customers such that the user can design strategy to entice more customers, retain them, and encourage them into being loyal customers.

FIG. 4E shows an example GUI 400e generated by the CRM tool based on the principles disclosed herein. The GUI 400e shows a customer lifecycle view, where the customers are segmented into four phases: a reach phase 4026, a convert phase 4028, an engage phase 4030, and a delight phase 4032. The reach phase 4026 corresponds an initial phase comprising potential customers that are followers of the current entity. As shown, there are 80,000 followers with a potential value of $500,000; and the month over month following has increased by 200%. The convert phase 4028 corresponds to a phase where some of the potential customers have performed at least one action associated with the current entity. For example, the customers in the convert phase 4028 may have visited a website of the current entity. As shown, the potential value at this phase is $50,000 with 2,000 website visitors; and the month to month traffic has increased by 13%. The engage phase 4030 includes customers that have already established a purchase relationship with the current entity. As shown, there are 1,000 engaged customers with $50,000 of potential value, and the month-to-month customer engagement has increased by 13%. Finally, the delight phase 4032 includes the customers that have been delighted (e.g., getting a VIP treatment), and therefor have become repeat customers. As shown, there are 300 repeated customers.

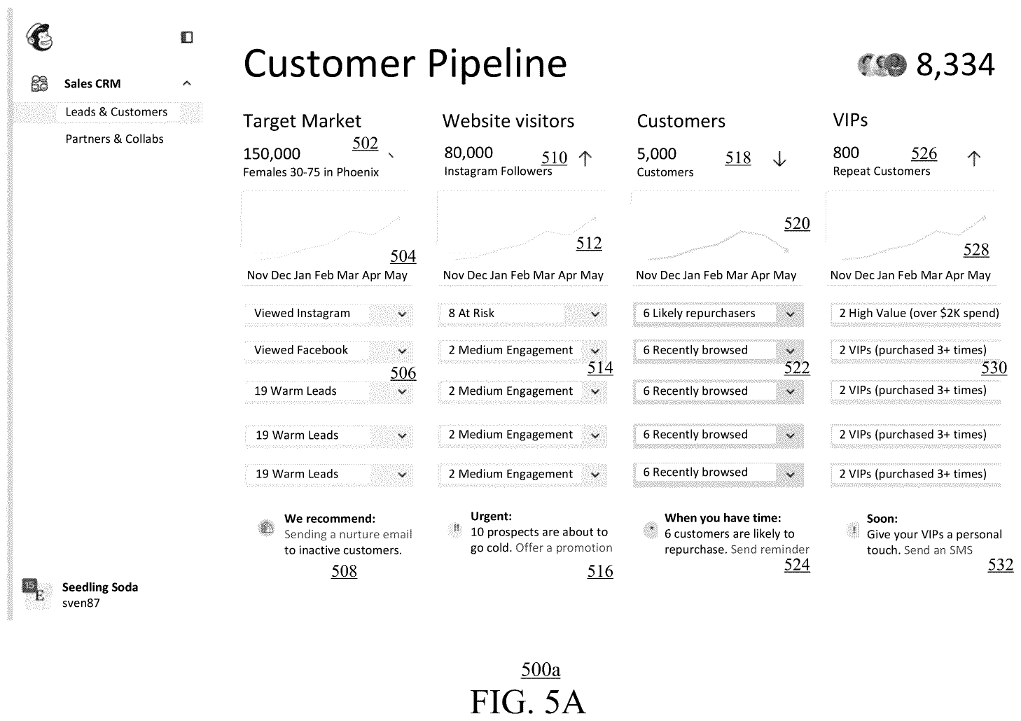

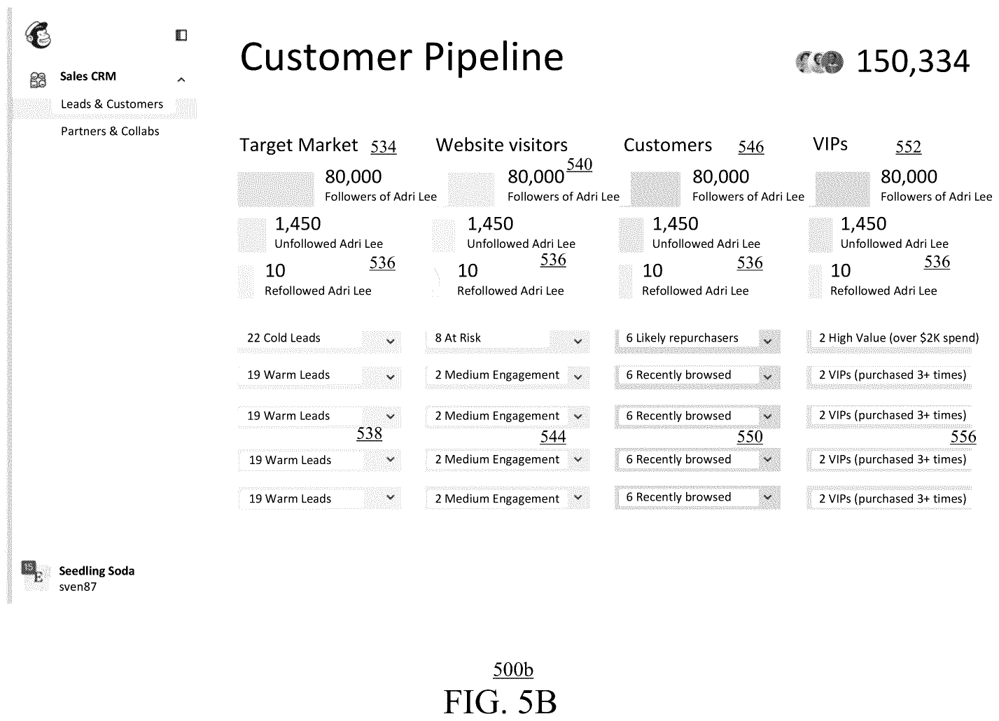

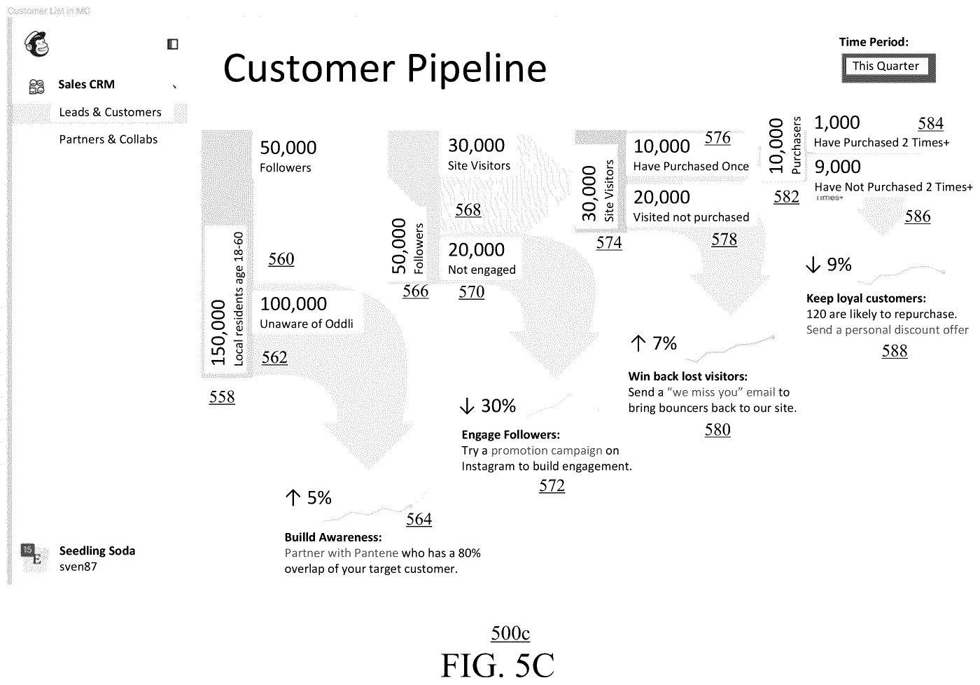

FIG. 5A shows an example GUI 500a generated by a CRM tool based on the principles disclosed herein. As shown, the GUI 500a depicts a customer pipeline view with four example phases: a target market phase 502, a website visitors phase 510, a customers phase 518, and a VIP phase 526. The target market phase 502 is an initial phase with general information about customers that may be interested in the current entity. For example, the target market phase 502 may contain 150,000 females at the age of 30-75 in Phoenix. A graph 504 shows a trend (e.g., increasing) of the of the target customers. Additionally, the target market phase 502 shows different segments 506 for the target customers. As shown, the different segments 506 include target customers that have viewed social media posts associated with the current entity and the warm leads. Additionally, the target market phase 502 shows a recommended action 508. Here the recommended action 508 is to send a nurturing e-mail to inactive customers.

The website visitors phase 510 includes potential customers that have visited a website associated with the current entity. The potential customers include 80,000 followers of Instagram page of the current entity. A graph 512 shows the trend of the potential customers at this phase. Furthermore, the potential customers in this phase are segmented into multiple segments 514. For example, there are potential customers at risk and potential customers that have just a medium level engagement. Additionally, the website visitors phase 510 includes a recommended urgent action 516. As shown, the recommend urgent action includes an indication that 10 prospects (i.e., potential customers) are about to go cold, and provides an option to offer a promotion.

The customers phase 518 includes current customers (as shown 5,000 current customers). Additionally, a graph 520 shows the trend of the current customers (as shown, peaked and going down). Additionally, the customers phase 518 includes different segments 522. As shown, the segments 522 includes likely repurchases and repurchasers. Furthermore, the customers phase 518 includes a recommended action 524 (which may be a low priority action). As shown the recommended action 524 include an indication that 6 customers are likely repurchase and an option for sending a reminder to these customers.

The VIPs phase 526 includes information about repeat customers (as shown, 800). A graph 528 shows the trend for these repeat customers—as shown, the trend for repeat customers have been going up. Additionally, the VIPs phase 526 include different segments 530, which, for example, may include repeat customers who have more than $2K spend and other repeat customers that have made purchases more than 3 times. Furthermore, the VIPs phase 526 includes a recommended action 532 (which may be a high priority action), which indicates that the repeat customers should be given a personal touch by sending an SMS. The recommended action 524 also provides an option for sending the SMS.

FIG. 5B shows an example GUI 500b generated by the CRM tool, based on the principles disclosed herein. The GUI 500b shows a customer pipeline view that is alternative to pipeline view shown in FIG. 5A. As shown, the GUI 500b shows four example phases: a target market phase 534, a followers phase 540, a customers phase 546, and a VIPs phase 552. The target market phase 534 includes 80,000 followers of the current entity. Additionally, the target market phase 534 includes graphs 536 (the graphs 536 are carried over to the later phases 540, 546, 552) showing the followers that have unfollowed and also refollowed the current entity. Additionally, the target market phase 534 includes different segments 538

The followers phase 540 includes customers that follow the target entity in one or more social media platforms. The followers phase 540 also includes segments 544, for example, to indicate at risk customers and medium engagement customers. The customers phase 546 includes customers that have performed one or more purchase transactions with the current entity. The customers phase 546 also has multiple segments 550, for example, likely repurchasers segment and recently browsed segment. The VIPs phase 552 includes repeat customers or more loyal customers. The VIPs phase 552 is also segmented into different segments 556, for example, VIP customers with spending over $2K and VIP customers with purchases more than 3 times.

FIG. 5C shows an example GUI 500c generated by the CRM tool, based on the principles disclosed herein. The example GUI 500c shows an alternate customer pipeline view containing four example phases. A first phase includes target customers 558 comprising 150,000 local residences between ages 18-60. Out of these target customers 558, customers 560 (50,000 in number) are followers of the current entity, while customers 562 (100,000 in number) are unaware of the current entity. The first phase further includes a recommended action 564 that allows the user to partner with another entity which has 80% overlap with another entity.

A second phase includes customers 566 (i.e., 50,000 customers) who are followers of the current entity. Out of these customers 566, customers 568 are site visitors (30,000 in number) and customers 570 (20,000 in number) are not engaged. The second phase further includes a recommended action 572 that allows the user to engage the followers by trying a promotion campaign on a social media platform to build engagement.

A third phase includes customers 574 (i.e., 30,000 customers) that have visited the website of the current entity. Out of the customers 574, customers 576 (10,000 in number) have purchased once and customers 578 (20,000 in number) have visited but not purchased. The third phase also provides a recommended action 580 that allows the user to win back lost visitors by sending an e-mail (e.g., “we miss you” e-mail) to bring the non-purchasers back to the website.

A fourth phase includes customers 582 (i.e., 10,000 customers) that have purchased from the current entity's website. Out of the customers 582, there are customers 584 (1,000 in number) have purchased 2 times and customers 586 (9,000 in number) that have not purchased 2 times. The fourth phase further includes a recommended action 588 indicating that some customers are likely to repurchase and providing an option to personal discount offer.

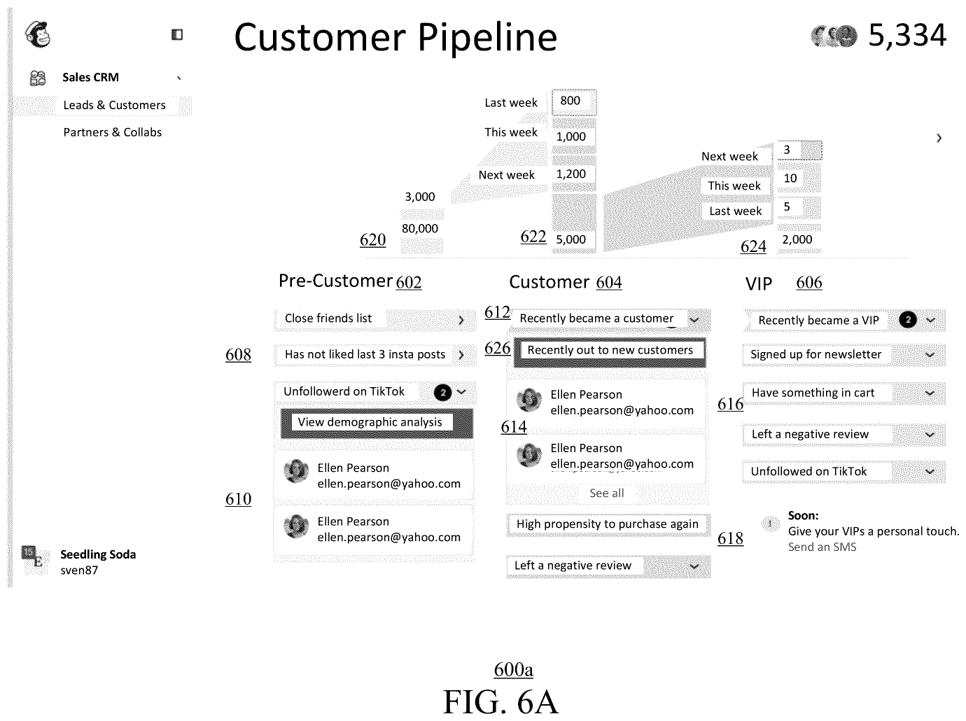

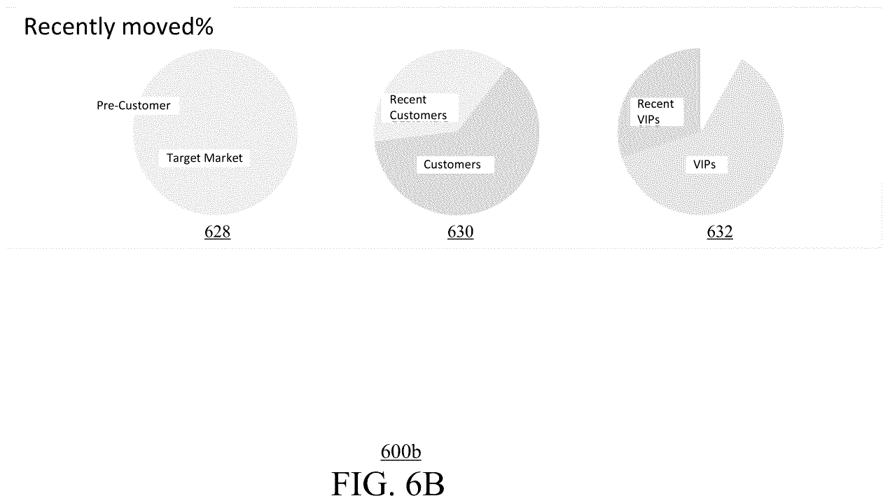

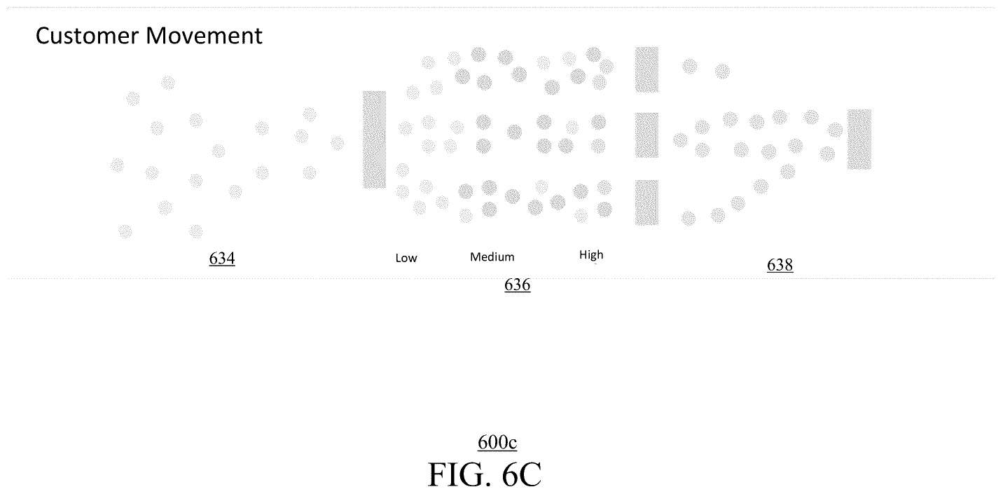

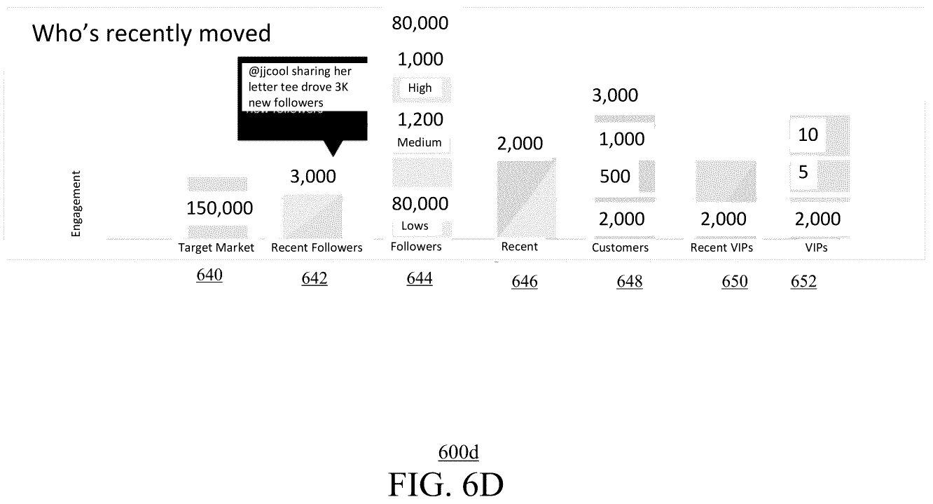

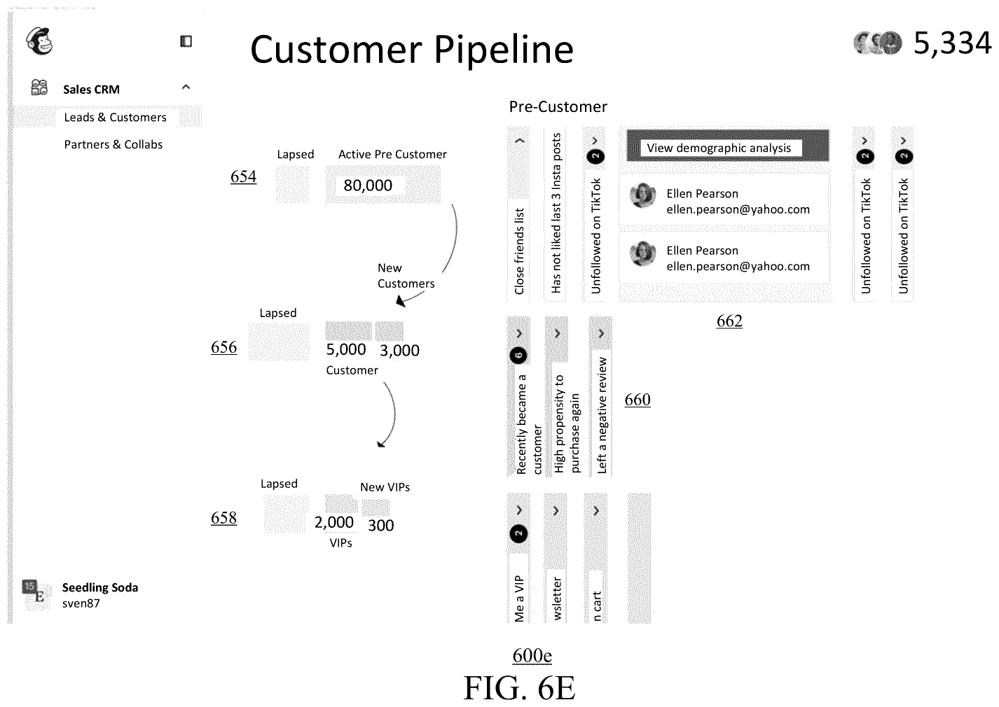

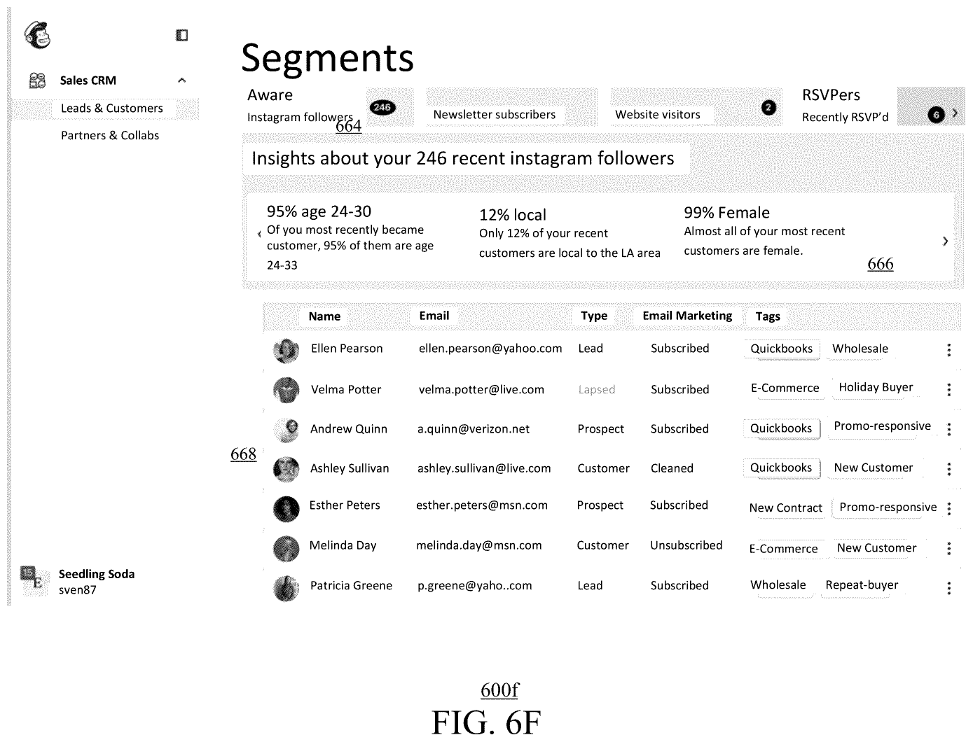

FIG. 6A shows an example GUI 600a generated by the CRM tool based on the principles disclosed herein. The GUI 600a shows an example customer pipeline, which includes a pre-customer phase 602, a customer phase 604, and a VIP phase 606. Within the pre-customer phase, there are different segments 608, for example, potential customers that are close friends of existing customers, potential customers that have not liked past three social media posts, or potential customers that have unfollowed the current entity on a social media platform. Additionally, the pre-customer phase 602 includes information about individual customers 610. The customer phase 604 also includes segmentation of the customers into different segments 612 such as, for example, recently became a customer, high propensity to purchase again, and left a negative review. Additionally, the customer phase 604 provides information about individual customers 614, also provide an option 626 to engage with the new customers. The VIP phase 606 includes customers that have made repeated purchases through the current entity. The VIP phase 606 is also segmented into multiple segments 616. The segments 616 include, for example, recently became a VIP, signed up for newsletter, have something in cart, left a negative review, unfollowed on a social media platform, etc. The VIP phase 606 also include a recommended action 618 to engage with the VIP customers, for example, to provide a personal touch to the VIPs by sending an SMS.

Additionally, the GUI 600a shows graphs 620, 622, 624 showing customer movement between the different phases. For example, graph 620 shows the number of customers that have moved (and/or projected to move) from the pre-customer phase 602 to the customer phase 604 (as shown, 300 customers). Out of the 3000 customers, 800 of them moved last week, 1000 moved this week, and 1200 are projected to move next week. Graph 622 shows the number of customer that have moved (and/or projected to move) from the customer phase 604 to the VIP phase 606. As shown, 5 customers moved last week, 10 customers have moved this week, and 3 customers are projected to move this week. Graph 624 shows the customers at the VIP phase 606. As the graphs 620, 622, 624 are organized as a continuum, the user can easily ascertain the flow (and/or projected flow) between the different phases 602, 604, 606.

FIG. 6B shows an example GUI 600b generated by the CRM tool based on the principles disclosed herein. Particularly, the GUI 600b shows recent movement of customers, for example, in terms of percentages. For instance, a first pie chart 628 illustrates the percentage of the target market converted to pre-customers. As another example, a second pie chart 630 shows what percentage of customers are recent customers. As yet another example, a third pie chart 632 shows what percentage of VIP customers are recent VIP customers.

FIG. 6C shows an example GUI 600c generated by the CRM tool based on the principles disclosed herein. Particularly, GUI 600c shows movement of customers across different phases, for example, customers 634 in a first phase, customers 636 in a second phase, and customers 638 in a third phase. At each phase, the customers can be color coded to show the percentage of customers that have been converted to the phase recently versus the customers that have been at the corresponding phase for a while. Additionally, customers 636 in the second phase include different types of customers: customers with low engagement, customers with medium engagement, and customers with high engagement. Furthermore, the user can configure the GUI 600c to show snapshot views at different times, such that the user can track the progress of the customers moving through the different phases.

FIG. 6D shows an example GUI 600d generated by the CRM tool based on the principles disclosed herein. Particularly, GUI 600d shows customers at different levels of engagement. As shown, a target market 640 includes 150,000 potential customers. Recent followers 642 include customers, as shown, that followed the current entity based on a share by an existing customer. Followers 644 include 80,000 low engagement customers, 1,200 medium engagement customers, and 1,000 high engagement customers. Recent customers 646 includes 2,000 customers, and current customers include 3,000 customers (including the recent 2,000 customers). Recent VIPs 650 include 2,000 customers and the VIPs 652 include 2,015 customers (including the recent 2,000 VIPs).

FIG. 6E shows an example GUI 600e generated by the CRM tool based on the principles disclosed herein. Particularly, GUI 600e shows example phases: a pre-customer phase 654, a customer phase 656, and a VIP phase 658. Each of the phases 654, 656, 658 include multiple segments 660, which in turn includes multiple customers 662. Each phase 654, 656, 658 shows new, currently active, and lapsed customers. Therefore, GUI 600e will show a snapshot view of movement of the customers across the different phases 654, 656, 658.

FIG. 6F shows an example GUI 600f generated by the CRM tool based on the principles disclosed herein. Particularly, GUI 600f shows a segment view with information about different customers in a segment—in the illustrated example, an aware segment 664 is shown. The aware segment 664 includes customers who have recently followed the current entity in a social media platform. The GUI 600f also shows demographic information 666 of the segment. As shown, the demographic information 666 indicates that 95% of the aware customers are between the age 24-40, 12% are local, and 99% are female. Additionally, the GUI 600f shows information about individual customers 668. Therefore, the GUI 600f provides a snapshot view of any segment that the user can drill down to any level, as desired.

One of more of the GUIs described above and the actions therein (e.g., recommended actions) may be generated by machine learning models. Some non-limiting examples of machine learning models include linear regression, decision trees, random forest, XGBoost, etc.

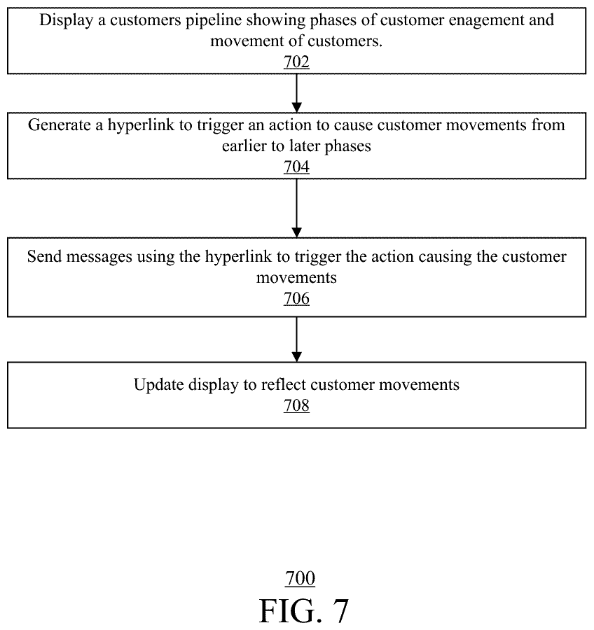

FIG. 7 shows a flow diagram of an example method 700 based on the principles disclosed herein. It should, however, be understood that the steps of the method 700 are provided as examples and should not be considered limiting. Therefore, methods with alternative, additional, or fewer number of steps should be considered within the scope of this disclosure.

The method begins at step 702 when a customers pipeline is displayed. The displayed customers pipeline includes phases of customer engagement (e.g., pre-customer, customer, VIP, etc.) and movement of customers between the phases.

Some non-limiting examples of the displayed pipeline include GUIs 400c (shown in FIG. 4C), 500c (shown in FIG. 5C), 600a (shown in FIG. 6A). At step 702, a hyperlink may be generated to trigger an action to cause customer movement from earlier to later phases. The hyperlink can include links to send e-mails, texts, promotions, etc. to the customers to cause the movements. Some non-limiting examples of such hyperlinks are shown in GUIs 200c (shown in FIG. 2C), 200e (shown in FIG. 2E), 400a (shown in FIG. 4A), 400b (shown in FIG. 4B), 400c (shown in FIG. 4C), 500a (shown in FIG. 5A), 500c (shown in FIG. 5C), etc.

At step 706, the hyperlink may be used to send messages to trigger the action causing the customer movements. The movements are generally from lower engagement toward higher engagement. At 708, the display may be updated to reflect the customer movements. Therefore, a user can conveniently—and without specialized programming knowledge—drive engagement with the customers using the method 700.

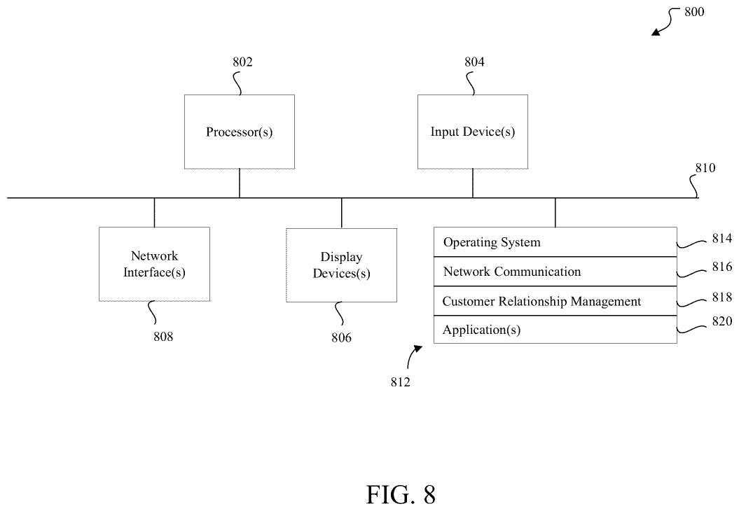

FIG. 8 shows a block diagram of an example computing device 800 that implements various features and processes based on the principles disclosed herein. For example, computing device 800 may function as first server 120, second server 130, client 150a, client 150b, or a portion or combination thereof in some embodiments. The computing device 800 also performs one or more steps of the method 700. The computing device 800 is implemented on any electronic device that runs software applications derived from compiled instructions, including without limitation personal computers, servers, smart phones, media players, electronic tablets, game consoles, email devices, etc. In some implementations, the computing device 800 includes one or more processors 802, one or more input devices 804, one or more display devices 806, one or more network interfaces 808, and one or more computer-readable media 812. Each of these components is be coupled by a bus 810.

Display device 806 includes any display technology, including but not limited to display devices using Liquid Crystal Display (LCD) or Light Emitting Diode (LED) technology. Processor(s) 802 uses any processor technology, including but not limited to graphics processors and multi-core processors. Input device 804 includes any known input device technology, including but not limited to a keyboard (including a virtual keyboard), mouse, track ball, and touch-sensitive pad or display. Bus 810 includes any internal or external bus technology, including but not limited to ISA, EISA, PCI, PCI Express, USB, Serial ATA or FireWire. Computer-readable medium 812 includes any non-transitory computer readable medium that provides instructions to processor(s) 802 for execution, including without limitation, non-volatile storage media (e.g., optical disks, magnetic disks, flash drives, etc.), or volatile media (e.g., SDRAM, ROM, etc.).

Computer-readable medium 812 includes various instructions 814 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 804; sending output to display device 806; keeping track of files and directories on computer-readable medium 812; controlling peripheral devices (e.g., disk drives, printers, etc.) which can be controlled directly or through an 1/O controller; and managing traffic on bus 810. Network communications instructions 816 establish and maintain network connections (e.g., software for implementing communication protocols, such as TCP/IP, HTTP, Ethernet, telephony, etc.).

Customer Relationship Management 718 include instructions that implement the disclosed interfaces and processes for customer relationship management.

Application(s) 820 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computer-implemented method comprising:
receiving customer data from a third party platform;
determining movement of the customers between a plurality of phases based on the received customer data;
displaying a customers pipeline user interface having a customers pipeline comprising a plurality of phases of customer engagement with an entity and showing the movement of customers between the plurality of phases, the customers pipeline user interface comprising:
the plurality of phases being organized horizontally across the interface;
potential value of each of the plurality of phases;
identification and contact information about individual customers organized vertically below a corresponding phase;
the individual customers being segmented based on a level of engagement within the corresponding phase;
a total number of customers in a right upper corner;
automatically generating, based on a current phase of customer engagement, a hyperlink within the user interface to trigger an action to cause movement of a first customer from a current phase of customer engagement to a later phase of customer engagement, the action comprising at least one of a recommended action, an urgent action, a low priority action, or a high priority action, the hyperlink being displayed directly below the corresponding phase, the hyperlink configured to generate a customized message;
responsive to receiving a selection of the hyperlink, using a message client to trigger the action by sending the customized message to the first customer, while remaining at the customers pipeline user interface;
receiving an indication that the first customer has moved from the current phase to the later phase in response to the customized message; and
responsive to receiving the indication, updating the display of the customers pipeline user interface to show the movement of the first customer.

2. The computer-implemented method of claim 1, further comprising:
providing one or more configurable templates;
receiving configuration parameters for the one or more configurable templates; and
generating the customers pipeline user interface based on the one or more configurable templates and the configuration parameters.

3. The computer-implemented method of claim 2, wherein receiving the configuration parameters further comprises:
receiving at least one of the plurality of phases, a plurality of segments within the plurality of phases, conditions for customers to be in a phase of the plurality of phases, and conditions for customers to be in a segment of the plurality of segments.

4. (canceled)

5. The computer-implemented method of claim 1, further comprising:
receiving a selection of a segment in the plurality of phases of customer engagement; and
updating the display of the customers pipeline user interface to show details of the selected segment.

6. The computer-implemented method of claim 1, further comprising:
receiving a selection of a segment in the plurality of phases of customer engagement; and
updating the display of the customers pipeline user interface to show a list of customers in the selected segment.

7. The computer-implemented method of claim 1, further comprising:
receiving a selection of a customer in the plurality of phases of customer engagement; and
updating the display of the customers pipeline user interface to show details of the selected customer.

8. The computer-implemented method of claim 1, wherein sending the customized message to the first customer comprises:
sending at least one of an e-mail message, text message, a promotion message, or a social media engagement message.

9. The computer-implemented method of claim 1, further comprising:
updating the display of the customers pipeline user interface to show a snapshot view of the customers pipeline.

10. (canceled)

11. A system comprising:
a non-transitory storage medium storing computer program instructions; and
a processor configured to execute the computer program instructions to cause operations comprising:
receiving customer data from a third party platform;
determining movement of the customers between a plurality of phases based on the received customer data;
displaying a customers pipeline user interface having a customers pipeline comprising a plurality of phases of customer engagement with an entity and showing the movement of customers between the plurality of phases, the customers pipeline user interface comprising:
the plurality of phases being organized horizontally across the interface;
potential value of each of the plurality of phases;
identification and contact information about individual customers organized vertically below a corresponding phase;
the individual customers being segmented based on a level of engagement within the corresponding phase;
a total number of customers in a right upper corner;
automatically generating, based on a current phase of customer engagement, a hyperlink within the user interface to trigger an action to cause movement of a first customer from a current phase of customer engagement to a later phase of customer engagement, the action comprising at least one of a recommended action, an urgent action, a low priority action, or a high priority action, the hyperlink being displayed directly below the corresponding phase, the hyperlink configured to generate a customized message;
responsive to receiving a selection of the hyperlink, using a message client to trigger the action by sending the customized message to the first customer, while remaining at the customers pipeline user interface;
receiving an indication that the first customer has moved from the current phase to the later phase in response to the customized message; and
responsive to receiving the indication, updating the display of the customers pipeline user interface to show the movement of the first customer.

12. The system of claim 11, the operations further comprising:
providing one or more configurable templates;
receiving configuration parameters for the one or more configurable templates; and
generating the customers pipeline user interface based on the one or more configurable templates and the configuration parameters.

13. The system of claim 12, wherein receiving the configuration parameters further comprises:
receiving at least one of the plurality of phases, a plurality of segments within the plurality of phases, conditions for customers to be in a phase of the plurality of phases, and conditions for customers to be in a segment of the plurality of segments.

14. (canceled)

15. The system of claim 11, the operations further comprising:
receiving a selection of a segment in the plurality of phases of customer engagement; and
updating the display of the customers pipeline user interface to show details of the selected segment.

16. The system of claim 11, the operations further comprising:
receiving a selection of a segment in the plurality of phases of customer engagement; and
updating the display of the customers pipeline user interface to show a list of customers in the selected segment.

17. The system of claim 11, the operations further comprising:
receiving a selection of a customer in the plurality of phases of customer engagement; and
updating the display of the customers pipeline user interface to show details of the selected customer.

18. The system of claim 11, wherein sending the customized message to the first customer comprises:
sending at least one of an e-mail message, text message, a promotion message, or a social media engagement message.

19. The system of claim 11, the operations further comprising:
updating the display of the customers pipeline user interface to show a snapshot view of the customers pipeline.

20. (canceled)
